(19) United States
(12) Patent Application Publication
(10) Pub. No.: US 2023/0375497 A1
(43) Pub. Date: Nov. 23, 2023

(54) Microelectrode Based Electrochemical Cell

(71) Applicant: New Jersey Institute of Technology, Newark, NJ (US)

(72) Inventors: Sagnik Basuray, Parsippany, NJ (US); Zhenglong Li, Newark, NJ (US)

(73) Assignee: New Jersey Institute of Technology, Newark, NJ (US)

(21) Appl. No.: 18/200,412

(22) Filed: May 22, 2023

Related U.S. Application Data
(60) Provisional application No. 63/344,775, filed on May 23, 2022.

(51) Int. Cl. G01N 27/403; G01N 27/36

(52) U.S. Cl. CPC G01N 27/403; G01N 27/36

(57) ABSTRACT

Disclosed is a NP-μFEC (non-planar microfluidic electrochemical cell) or a reusable microfluidic electrochemical cell with a multiple three-dimensional (3D) non-planar interdigitated microelectrode array with minimal sample volume and enhanced electric fields penetration for highly sensitive electrochemical analysis. This demonstrates that cost-effective, easy-to-fabricate NP-μFEC can be an ideal new analytical lab-on-a-chip microfluidic platform for sensitive analyte inorganic heavy metals detection.

### CROSS-REFERENCE TO RELATED APPLICATION

This application claims the benefit of priority under 35 U.S.C. § 119 of U.S. provisional patent application Ser. No. 63/344,775, filed May 23, 2022. The foregoing application is incorporated herein by reference in its entirety for all purposes.

### STATEMENT REGARDING FEDERALLY SPONSORED RESEARCH

This invention was made with government support under Agreement No. 1751759 awarded by the National Science Foundation. The government has certain rights in the invention.

### FIELD OF THE DISCLOSURE

The present disclosure relates to a microfluidic device. In particular, the present disclosure relates to a highly sensitive, easy-and-rapidly-fabricable microfluidic electrochemical cell with an enhanced three-dimensional electric field.

### BACKGROUND

Rapid, cost-effective, highly sensitive, and label-free detection characteristics of microfluidic electrochemical cells (μFECs) are receiving increasing attention [see references 1, 2 and 3 to Daniels, Li, and Chatterjee, respectively]. In the past decade, there have been significant efforts to design and optimize microfluidic electrochemical cells' electrode architecture to fabricate analytical devices with high sensitivity, accuracy, and reproducibility [see references 4, 5 and 6 to Min, Rooney and Lee, respectively]. Microelectrodes (μEs), an essential component in microfluidic electrochemical cells, offer high sensitivity than macroelectrodes of conventional size due to their smaller area-edge effects [see reference 4 to Min]. Various μE geometries have been evaluated and applied to microfluidic electrochemical cells [see references 7, 8 and 9 to Ciszkowska, Nishizawa and Kawiak, respectively].

A pair of comb-like metal electrodes on a planar insulating substrate, as shown in FIG. 1(a), is called planar interdigitated microelectrodes (P-IDμEs). The interdigitated layout of the electrode fingers endow P-IDμEs with promising advantages, e.g., the fast establishment of the steady-state, low ohmic drop, increased signal-to-noise ratio [see references 3 and 4 to Chatterjee and Min, respectively]. However, for the P-IDμEs, due to the adjacent electrode fingers applied with opposite voltages, the electric field is chiefly localized near the μE surface, as shown in FIG. 1(b) [see references 10 and 11, to Bratov and Van Gerwen, respectively]. The 2D electric field limits the penetration of the electric field, leading to a loss in sensitivity for P-IDμE, specifically for impedance-based sensing. [see references 12, 13 and 14 to Cheng, Ruth and Cheng, respectively].

Researchers have employed different methodologies to address this problem, as (i) including nanomaterials to increase the active electrode surface area or (ii) designing an elaborate device structure. It is shown by reference 15 to Sujime that carbon nanotubes (CNT) forests on μEs significantly enhance transducer detection performance. The P-IDμEs-based transducer sensitivity improved considerably by extending the active detection area using carbon spacer/carbon nanostructures. Reference 16 to Abellán-Llobregat et al. employed a microfluidic electrochemical cell with hybrid μEs comprised of graphene oxide decorated with gold nanoparticles to successfully detect uric acid and ascorbic acid in urine samples at detection limits of 0.62 μM and 1.4 μM, respectively. Recently, as shown in reference 10 to Bratov et al., the concept of three-dimensional (3D) IDμE with electrode fingers separated by an insulating SiO₂ barrier was introduced see references 10 and 17 to Bratov and Bratov, respectively]. This 3D electrode architecture allows prolonging the current transmission path along the barrier's surface, enhancing the device's sensitivity toward probing reactions of biomolecules attached to the barrier surface. However, all of the above microfluidic electrochemical cells and others in the literature require complicated, time-consuming, and expensive device construction processes despite the mentioned advantages [see references 18 and 19 to Young and Daniel, respectively].

It has been demonstrated that packing a 2-electrode non-planar IDμE (NP-IDμE or non-planar interdigitated microelectrode) based microfluidic electrochemical cell (NP-μFEC) could allow one to use it as an excellent electrochemical impedance transducer [see references 21 and 22 to Cheng and Basuray, respectively]. The 2-electrode NP-μFEC is a sensitive affinity-based impedance sensor has been established using electrochemical impedance spectroscopy (EIS), which has enhanced 3D electric field penetration. However, detection of molecules that lack suitable capture probes (like dopamine, uric acid, and heavy metals), EIS cannot be used as the detection mode.

For detecting these molecules, the electrochemical behavior of NP-μFEC, specifically in the DC modes (like cyclic voltammetry (CV) and differential pulse voltammetry (DPV)), needs to be characterized and fundamentally examined. A new 3-electrode NP-μFEC is disclosed herein that draws upon, inter alia, a fundamental study using simulations and experiments to visualize and demonstrate the new 3-electrode NP-μFEC as an analytical tool. Unless otherwise noted, the NP-μFEC appearing hereafter means the 3-electrode NP-μFEC.

### SUMMARY

In accordance with embodiments of the present disclosure, a highly sensitive, easy-and-rapidly-fabricable microfluidic electrochemical cell with an enhanced 3D electric field is disclosed. In one embodiment, an empty, fully integrated 3-electrode NP-μFEC (non-planar microfluidic electrochemical cell) is prepared. The empty, fully integrated 3-electrode non-planar microfluidic electrochemical cell could be used to ascertain its working potentiality under DC modes like cyclic voltammetry (CV) and differential pulse voltammetry (DPV).

In one embodiment, the electrochemical cell could include a top microelectrode layer, a bottom microelectrode layer, and a pressure-sensitive adhesive middle layer located between the top layer and the bottom layer. The top, middle, and bottom layers could cooperate to form a three-dimensional and non-planar structure.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed microfluidic electrochemical cell and associated systems and methods, reference is made to the accompanying figures, wherein:

FIG. 1a is a schematic diagram of P-IDμE (planar interdigitated microelectrode);

FIG. 1b shows the distribution of electric fields within P-IDμE (planar interdigitated microelectrode). Here, E_{H}, E_{W}, E_{G} represent the electrode height, width, and gap between adjacent electrode fingers, respectively;

FIG. 1c is a schematic diagram of a NP-IDμE (non-planar interdigitated microelectrode), in accordance with one embodiment of the present disclosure;

FIG. 1d shows the corresponding electric field distribution of the NP-IDμE (non-planar interdigitated microelectrode) of FIG. 1c;

FIGS. 2(a)-2(h) disclose top and bottom schematic diagrams of the Non-planar microfluidic electrochemical cell as well as results based on Non-planar microfluidic electrochemical cell;

FIGS. 3(a)-3(e), disclose μE (microelectrode) configuration of (a) P-μFEC (planar microfluidic electronic cell) and (b) NP-μFEC (non-planar microfluidic electronic cell) (cross-section) along with simulated electric field distributions;

FIGS. 4(a)-4(d) represent the spatial distribution of the electric field (from different angles) in P-μFEC (planar microfluidic electronic cell) and describe the spatial distribution of the electric field (from different angles) in NP-μFEC (non-planar microfluidic electronic cell);

FIGS. 5(a)-5(c) illustrate an equivalent circuit diagram; Nyquist plots obtained at different CE positions of NP-μFEC (non-planar microfluidic electronic cell); and Nyquist plots obtained at different CE positions of P-μFEC (planar microfluidic electronic cell);

FIGS. 6(a)-6(g) are DPV results obtained based on NP-μFEC (non-planar microfluidic electronic cell);

FIGS. 7(a) and 7(b) illustrate DL results based on NP-μFEC (non-planar microfluidic electronic cell) using different channel thicknesses;

FIG. 8 is schematic diagram of the preparation process for μE;

FIG. 9 is a scheme of the preparation process for NP-μFEC (non-planar microfluidic electronic cell);

FIGS. 10(a)-10(e) illustrate a schematic diagram of NP-μFEC (non-planar microfluidic electronic cell) and related data;

FIGS. 11(a)-11(d) illustrate CV test results obtained at different CE positions;

FIGS. 12(a)-12(c) illustrates CV test results obtained from KCl solution (1 M) at different CE positions;

FIG. 13. is an illustration of an electric field;

FIG. 14 is an illustration of a further electric field;

FIGS. 15(a1)-15(d2) illustrate the applied potential and corresponding electric field distribution in the NP-μFEC (non-planar microfluidic electronic cell);

FIGS. 16(a1)-16(b2) illustrate applied potential and corresponding electric fields further to FIGS. 15(a1)-15(d2);

FIGS. 17(a1)-17(b2) represent the concentration distribution of K₃Fe(CN)₆ and K₄Fe(CN)₆ within the channel of P-μFEC (planar microfluidic electronic cell), respectively;

FIGS. 18(a1)-18(a4) illustrate a Raw Nyquist plot and its corresponding fitted curve;

FIGS. 19(a1) and 19(a2) illustrate a raw Nyquist plot and its corresponding fitted curve;

FIGS. 20(a)-20(f) illustrate further curves with respect to FIGS. 19(a1) and 19(a2);

FIG. 21 illustrates I-E curves;

FIGS. 22(a)-22(c). Illustrates (a) DPV test results obtained under different electrode connection modes;

FIGS. 23(a)-23(d) illustrate (a) DPV test results are obtained with the disclosed configuration; and

FIGS. 24(a1)-24(d2) illustrate further DPV test results.

### DETAILED DESCRIPTION

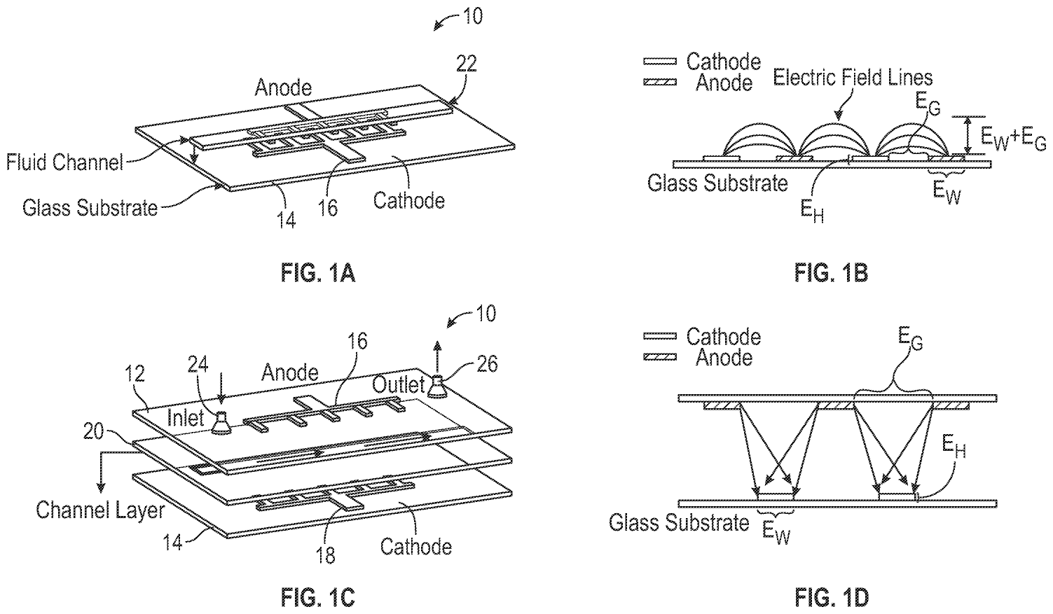

In the present disclosure, a fundamental study using simulations and experiments was undertaken to visualize and demonstrate exemplary embodiments of 3D non-planar microfluidic electrochemical cell as an analytical tool for CV and DPV modes. One embodiment of a non-planar microfluidic electrochemical cell is shown in FIG. 1(c). The 3D non-planar microfluidic electrochemical cell could provide the following advantages compared to conventional planar microfluidic electrochemical cell.

(1) Fabrication: In one embodiment, as shown in FIGS. 1a and 1c, non-planar microfluidic electrochemical cell 10 includes three layers; the top and bottom glass microelectrode layers 12, 14 decorated with respective first and second μE (microelectrode) arrays 16, 18 with a middle double-sided polyester-based pressure-sensitive adhesive (PSA) layer 20 with the desired channel pattern (60 mm×500 μm×140 μm in length×width×height, respectively). Middle double-sided polyester-based pressure-sensitive adhesive (PSA) layer 20 is sandwiched between first and second glass microelectrode (μE) layers 12, 14. Middle layer further includes fluid channel 22 in fluid communication with inlet 24 and outlet 26 formed on top glass microelectrode layer 12. The first and second μE (microelectrode) arrays 16, 18 (illustrated as an anode and a cathode, respectively) that are deposited on the respective top and bottom glass microelectrode layers 12, 14 could be used as a working electrode (WE), a counter electrode (CE), or the reference electrode (RE) during the electrochemical processes. Instead of bonding the top and bottom glass microelectrode layers 12, 14 together, the patterned middle PSA layer 20 could also work as a microfluidic channel. It will be understood that the number of layers could vary. Materials other than PSA could be used as the middle layer, such as silicone transfer film, polydimethylsiloxane (PDMS), or polyester (PET).

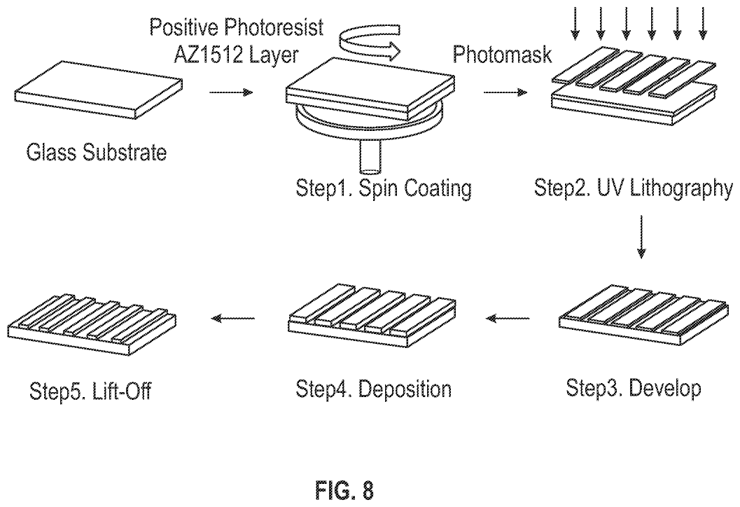

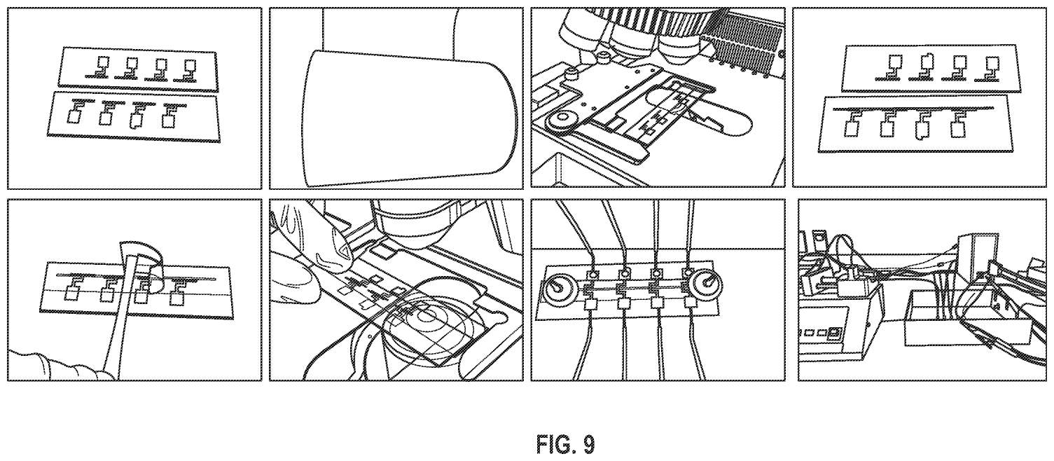

This embodiment allows the construction of a μFEC (microfluidic electronic cell) with a small sample volume, such as ˜4 μL. The detailed fabrication protocols of μE and the non-planar microfluidic electrochemical cell are shown in FIGS. 8 and 9, respectively. Using PSA as a middle layer allows the non-planar microfluidic electrochemical cell to generate a 3D electrode structure without extensive and costly fabrication steps [see reference 20 to Saha]. Further, the PSA layer provides the advantages of (i) a reasonably wide operating temperature window (−40° C. to 120° C.), (ii) fast and easy electrode assembly, (iii) and excellent reagent-resist properties. Thus, the fabrication process of the non-planar microfluidic electrochemical cell is simple, cost-effective, scalable, and accelerates non-planar microfluidic electrochemical cell adoption as an alternative to P-μFEC (planar microfluidic electronic cell) by other research groups.

(2) Electric Field: Another advantage of the non-planar microfluidic electrochemical cell is that it allows a vertical distributed electric field. The 3D spatial orientation of the μE arrays enables the electric field to penetrate through the whole channel layer, which is beneficial to impedance sensors (FIG. 1(d)). All the changes from the dielectric sensing materials packed between the μE layers can contribute to the final output signal [see references 21 and 22 to Cheng and Basuray, respectively].

(3) Fully Integrated: It is well documented that any alterations and modifications in electrode design such as the distances between the electrodes (working electrode (WE), the counter electrode (CE), and the reference electrode (RE)) and their relative positions can significantly alter electrochemical systems and lead to a drop in their performance [see references 23-26 to Zhang, Li, Cheng and Hsieh, respectively]. Furthermore, previous studies demonstrated that an internal pseudo-RE positioned inside the microchannel benefits μFEC (microfluidic electrochemical cell)s' sensitivity because of a smaller ohmic drop [see references 27 and 28 to da Silva and Li, respectively]. Therefore, in one embodiment, a non-planar microfluidic electrochemical cell with four pairs of NP-IDμE arrays inserted within a single microfluidic channel is prepared for electrochemical characterizations (CV, DPV, and EIS). It will be understood that the number of pairs of NP-IDμE arrays inserted within a single microfluidic channel could vary.

Aspects of certain embodiments of the present disclosure include:
(1) The prior art structure is more applicable to a 2-electrode system and is difficult in DC application modes (such as CV and DPV). The introduction of the third electrode (RE) in the present disclosure allows the present embodiment to be used in a 2-electrode or a 3-electrode system.
(2) Unlike introducing a separated RE, the insert of RE within the microfluidic channel in the present embodiment can significantly reduce the ohmic drop between the RE and WE, enhancing the device's detection performance.
(3) Embodiments of the present disclosure could be both non-planar and employ a 3D electrode structure. Since in impedance sensors, the penetration of electric fields is critical. Traditional planar distribution of the WE and CE will generate a limited electric field penetration, and this will result in the changes/captures/bindings that occur beyond the electric field penetration ranges that cannot contribute to the final signals. The three layer layout of the present embodiment can separate the WE and CE and generate a special orientation of the electric fields.

The electrochemical behavior of the 3D non-planar microfluidic electrochemical cell of the present disclosure is compared against a conventional 2D P-μFEC (2D planar microfluidic electrochemical cell) using a well-known redox probe potassium ferri/ferrocyanide (K₃/K₄Fe(CN)₆). The solution is kept stagnant to exclude the contribution of forced convection. Under the stagnant condition, the effect of the distance between the electrodes (WE, CE, and RE) and their final positions on the electrochemical behavior of non-planar microfluidic electrochemical cell are studied in detail. Finite element analysis (FEA) using COMSOL Multiphysics 5.5 is adopted to visualize the electric field distribution between the 3D non-planar microfluidic electrochemical cell of the present disclosure vs. a conventional 2D P-μFEC (planar microfluidic electrochemical cell).

Comparisons between the non-planar microfluidic electrochemical cell of the present disclosure and a conventional P-μFEC (planar microfluidic electrochemical cell) demonstrate that the transformation in electrode architecture brings a few interesting observations: (a) While in the P-μFEC (planar microfluidic electrochemical cell) a radial diffusion behavior is observed, the non-planar microfluidic electrochemical cell allows linear diffusion-controlled redox processes. (b) The influence of inserted RE and CE's positions on the electrochemical properties of the non-planar microfluidic electrochemical cell is studied in detail. For the non-planar microfluidic electrochemical cell, the inserted RE's position changes do not affect the CV, DPV electrochemical profiles. However, the spacing between the CE and WE does. (c) COMSOL Multiphysics validates enhanced electric field penetration in the non-planar microfluidic electrochemical cell. (d) Without any electrode surface modifications (like metal nanoparticles or CNT) non-planar microfluidic electrochemical cell shows a detection limit (DL) of ˜2.54×10⁻⁶ M for aqueous [Fe(CN)_{6]}^{3-/4-} probe, which is slightly larger than that of the P-μFEC (planar) microfluidic electrochemical cell) (˜1.8×10⁻⁶ M). It concludes that, even though the transition of μE (microelectrode) arrays from coplanar distribution to non-planar distribution will increase the diffusion distance of ions (from 10 μm to 140 μm), this does not significantly influence the μFEC's performance. (e) Finally, a constructed non-planar microfluidic electrochemical cell using three layers of PSA tapes as the spacer in one embodiment is employed for heavy metal detection. The DL of NP-μFEC for Cu²⁺, Fe³⁺, and Hg²⁺ are 30.5±9.5 μg L⁻¹, 181±58.5 μg L⁻¹, and 12.4±1.95 μg L⁻¹, respectively, which meets the US Environmental Protection Agency (EPA)'s water contamination level for Cu, Fe and is close to that for Hg (1300 μg L⁻¹, 300 μg L⁻¹, and 2 μg L⁻¹, respectively). Therefore, the acquired DLs demonstrate that the cost-effective, fast-preparation NP-μFEC of the present disclosure can be an ideal new analytical tool to other research groups for the applications of monitoring heavy metals (Cu, Fe, among others) in wastewater.

### Experimentation Section

Materials and Chemicals

The materials and the methods of the present disclosure used in one embodiment will be described below. While the embodiment discusses the use of specific compounds and materials, it is understood that the present disclosure could employ other suitable compounds or materials. Similar quantities or measurements may be substituted without altering the method embodied below.

Potassium chloride (KCl) and potassium ferri/ferrocyanide (K₃/K₄Fe(CN)₆) were purchased from Sigma-Aldrich. Mercury (II) chloride (98+%), Copper (II) chloride dihydrate (99+%), and Tris(2,2′-bipyridyl)ruthenium(II) chloride hexahydrate (>98%) were purchased from Thermo Scientific. Iron (III) chloride (anhydrous, 98+%) is obtained from Alfa Aesar. The de-ionized (DI) water used in the experiments was obtained from a Milli-Q® Direct 8 Water Purification System. Acetone 99.5% ACS) and isopropyl alcohol (99% ASC) purchased from VWR Chemicals BDH® are used to clean chips. Sulfuric acid (H₂SO₄, Catalog No.A300C-212) and hydrogen peroxide (H₂O₂, Catalog No.H312-500) were all acquired from Fisher Scientific™ and used for the removal of organic contaminants. Hexamethyldisilazane (HMDS) and AZ 1512 are obtained from MicroChem Corp and used to prepare photoresist layers. AZ300 MIF developer was supplied by EDM Performance Materials Corp and used in the developing process to make the underlying pattern visible. Finally, a double-sided PSA tape (ARcare® 90445) from Adhesives Research, Inc. was adopted to use as both an intermediate fluid channel and an adhesive layer to bond the top and bottom Pt μE layers. The glass substrate was diamond white glass obtained from Globe Scientific Incorporated.

Electrochemical Characterizations

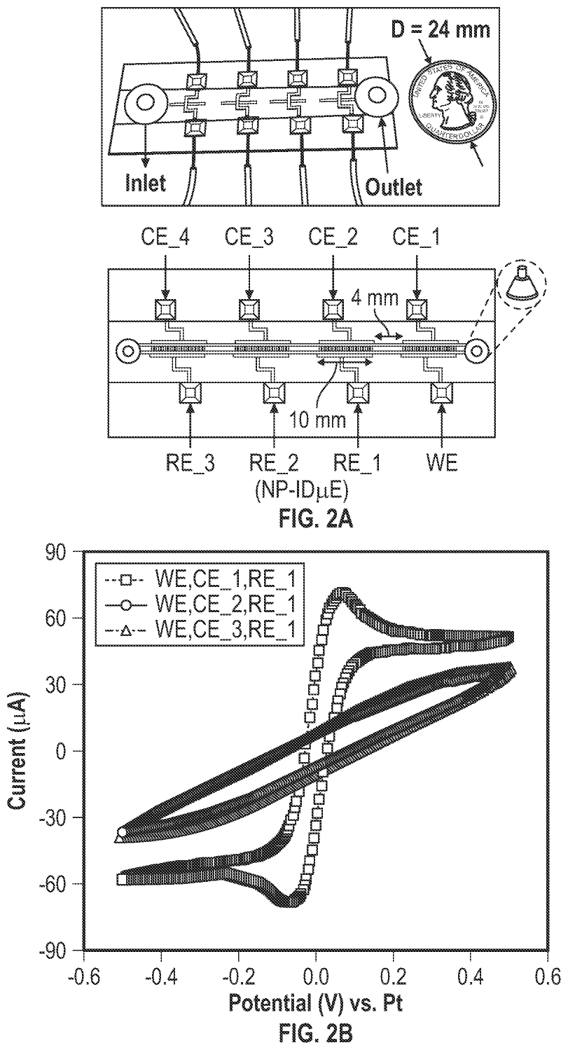

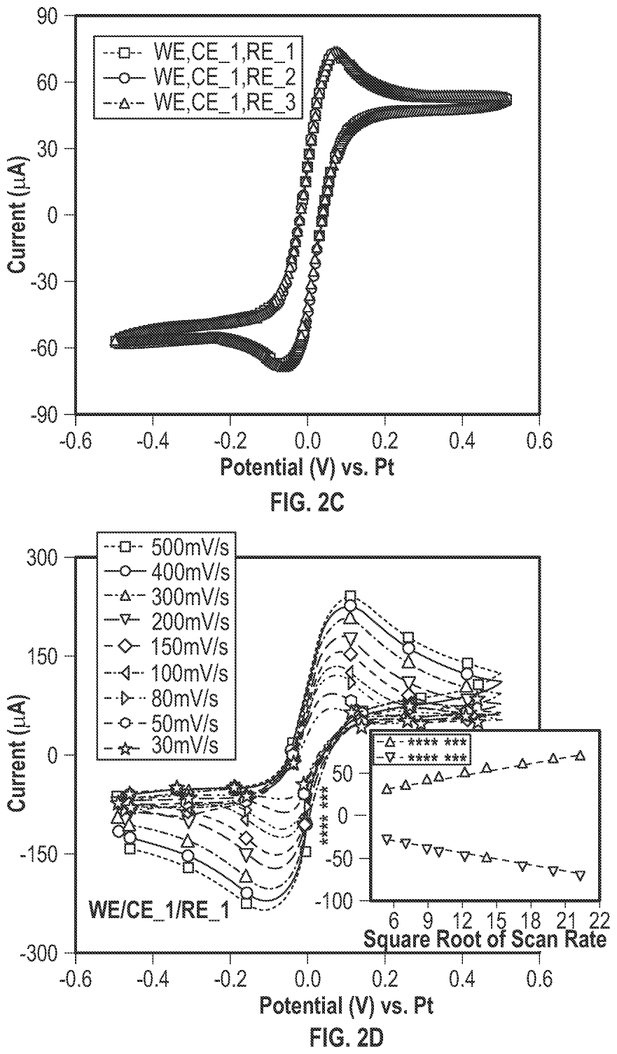

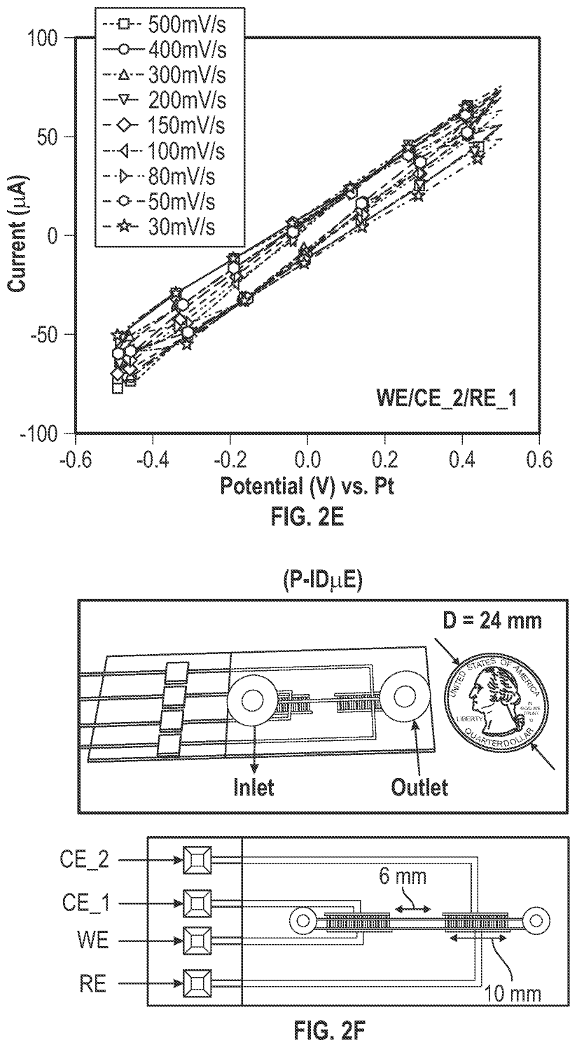

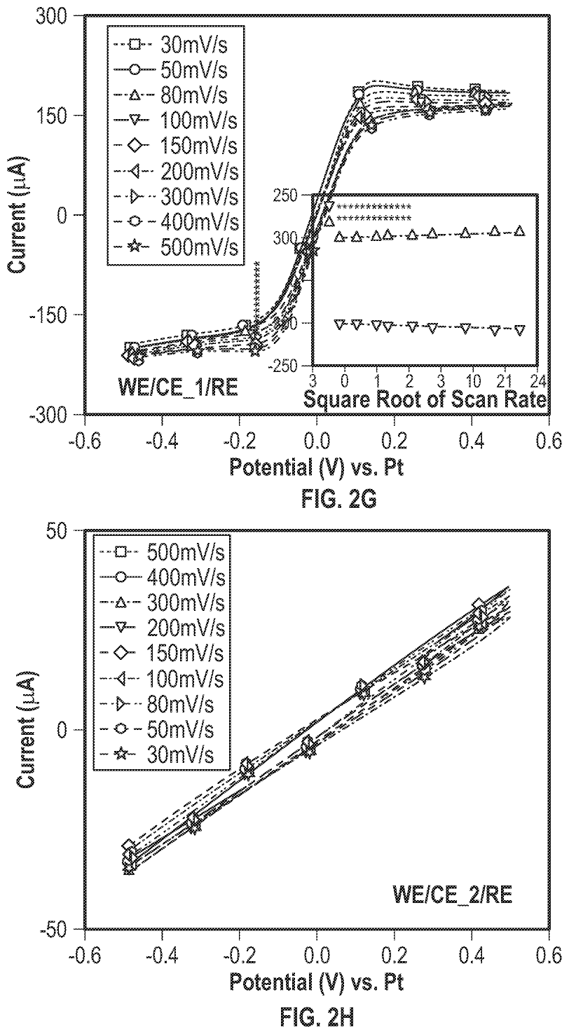

K₃[Fe(CN)₆] and K₄[Fe(CN)₆] (1:1, mole ratio) redox couple in KCl (1 M) were used to assess the electrochemical performance of this non-planar system. The CV, EIS, and DPV signals were obtained using a Gamry (Reference 600+) potentiostat since platinum (Pt)-based pseudo-RE provides a suitable option due to its longevity and easy fabrication. To simplify the process of device preparation in the present disclosure, all electrodes (WE, CE, pseudo-RE) were prepared using Pt metal, as shown in FIGS. 2(a)-2(h).

### Results & Discussion

The distances between the electrodes (WE, CE, and RE) and their relative placements are essential parameters to the performance and reliability of the NP-μFEC. In one embodiment, the NP-μFEC could include four sets of non-planar IDμE (interdigitated microelectrode) arrays. The length of one entire μE array is 10 mm, and the horizontal distance between adjacent μE arrays is ˜4 mm, as shown in FIG. 2 (a). The P-μFEC has two sets of planar IDμE arrays. The length of one μE array is 10 mm, and the horizontal distance between adjacent μE arrays is ˜6 mm, as shown in FIG. 2(b1). Table 4 summarizes geometric details of the Pt μE arrays. Different combinations of the μE arrays are used as WE, CE, and RE to study the relationship between electrochemical characterization techniques like CV, DPV, and EIS and their relative placements and distance between the WE, CE, and RE.

CV Characterization

NP-IDμE CV

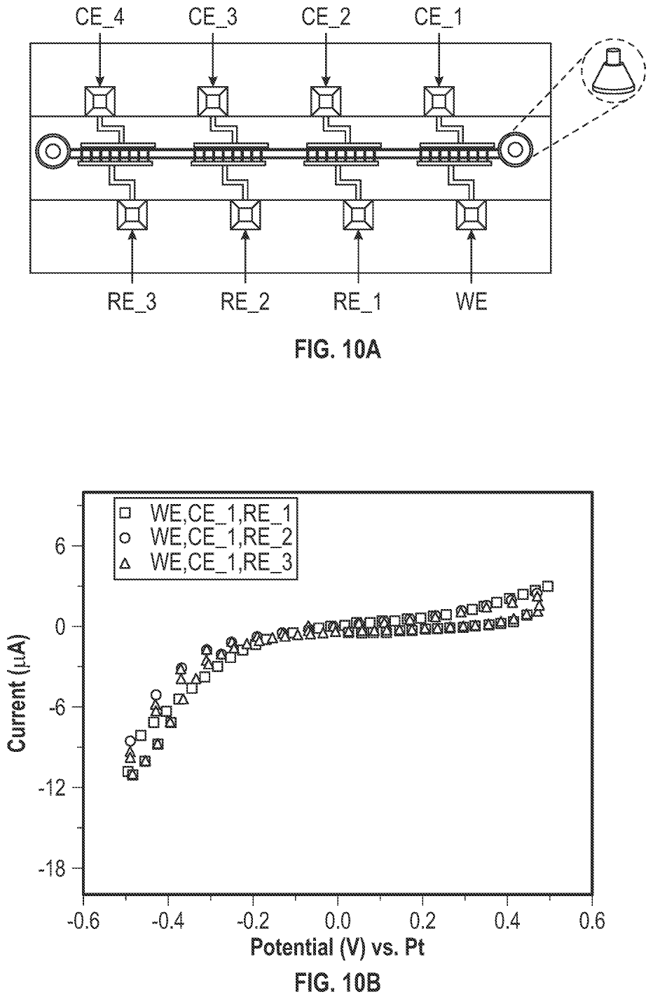

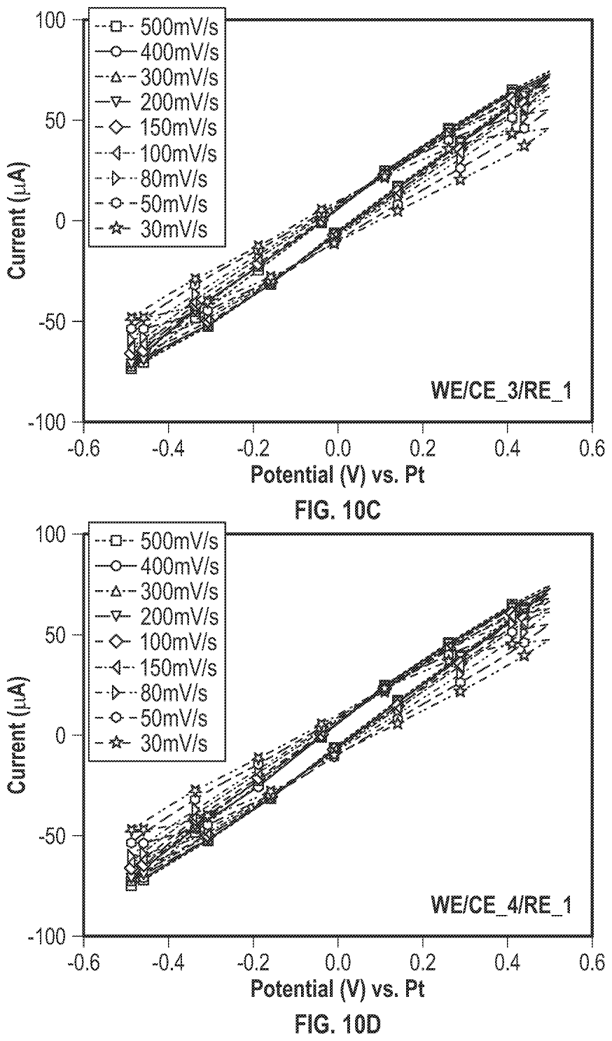

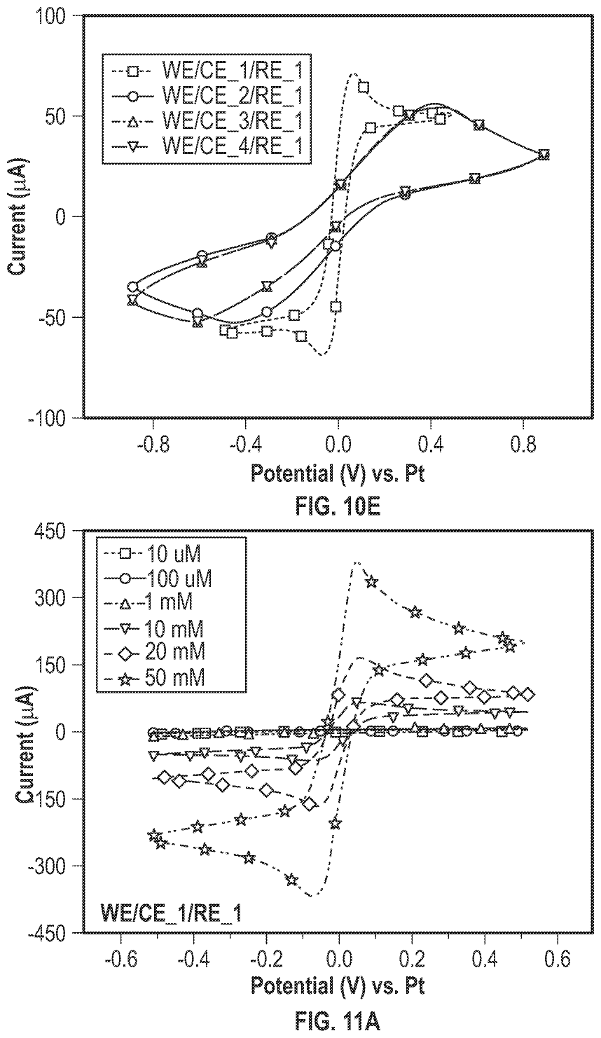

The voltammetric behavior for different μE configurations is shown in FIG. 2. The corresponding background currents are shown in FIG. 10(b).

FIG. 2. (a1) is a picture (top) and schematic diagram (bottom) of non-planar microfluidic electrochemical cell. Results (a2)-(a5) are obtained based on NP-μFEC. (a2) CV results at different CE positions, v=30 mV/s. (a3) CV results at different RE positions, v=30 mV/s. (a4) CV results under different v based on WE/CE_1/RE_1 configuration. The inset shows the peak current plots (I_{Pa}, I_{Pc}) versus the square root of scan rates (v^{1/2}) (from 30 to 500 mV/s). The equation of the anodic peak current (Iₚₐ) line: Iₚₐ (μA)=9.13×v^{1/2}+79.75; Coefficient of determination (R²)=0.98. The equation of the cathodic peak current (I_{pc}) line: I_{pc} (μA)=−9.89×v^{1/2}−62.15; R²=0.99. (a5) CV results under different v based on WE/CE_2/RE_1 configuration. (b1) Picture (top) and schematic diagram (bottom) of P-μFEC (planar microfluidic electrochemical cell). Results (b2)-(b3) are acquired based on P-μFEC (planar microfluidic electrochemical cell). Here, the solution is [Fe(CN)₆]^{3-/4-} (0.01 M) in KCl (1 M). (b2) CV results under different v based on WE/CE_1/RE configuration. Inset shows the peak current plots (Iₚₐ, I_{Pc}) versus v^{1/2}. The equation of Iₚₐ line: Iₚₐ (μA)=2.13×v^{1/2}+285.47; R²=0.8. The equation of I_{pc} line: I_{pc} (μA)=−2.73×v^{1/2}−285; R²=0.95. (b2) CV results obtained at different v based on WE/CE_2/RE configuration.

As shown in FIG. 2(b), for the WE/CE_1/RE_1 configuration, the voltammogram of 10 mM K₃[Fe(CN)₆] and K₄[Fe(CN)₆] (1:1, mole ratio) in KCl (1 M) at a scan rate (v) of 100 mV/s shows oxidation at anodic peak potential (Eₚₐ) of 75 mV and a back reduction at cathodic peak potential (E_{pc}) at −75 mV versus Pt RE, such that the peak-to-peak separation (ΔEₚ) is ca. 150 mV. As v is increased, Eₚₐ values move to more positive values while E_{pc} potentials are shifted to more negative values, resulting in an increase in the magnitude of ΔEₚ ((ΔEₚ @ v):170 mV @ 150 mV/s; 210 mV @ 400 mV/s). Conversely, lowering v results in decreasing ΔEₚ as ΔEₚ=125 mV at v=30 mV/s. In all cases, the apparent formal potential E^{0′} of [Fe(CN)₆]^{3-/4-} at the Pt WE equal to (Eₚₐ+E_{pc})/2=˜0 mV and independent of v.

The effect of v on peak currents of the cyclic voltammograms is also monitored. It is observed that for all the v studied, the ratio of the cathodic and anodic processes' peak currents (i_{pc}/iₚₐ) is consistently nearing 0.95, indicating the chemical reversibility as expected for the [Fe(CN)₆]^{3-/4-} redox process. Furthermore, as shown in the inset of FIG. 2(d), from 30 to 500 mV/s, peak currents (iₚₐ, i_{pc}) vs. square root of scan rate (v^{1/2}) show good adherence to linearity, demonstrating classical Nernstian diffusion-controlled redox behavior [see references 30, 31 and 32 to Tantang, Schroll and Elgrishi, respectively].

$${i}_{p} = 0.446 {{nFAC}^{o} ( \frac{{nFvD}_{o}}{RT} )}^{1 / 2} \qquad ( 1 )$$

The Randle-Sevcik Equation (1) can be used to calculate the cumulative active electrode surface area (Areal). Using the literature value of diffusion coefficients (7.3×10⁻⁶ cm²/s for [Fe(CN)₆]³⁻ [see reference 33 to Konopka]; 6.3×10⁻⁶ cm²/s for [Fe(CN)₆]⁴⁻ [see reference 34 to Chang]), the corresponding Areal are determined as 4.37×10⁻² cm² and 4.62×10⁻² cm², respectively. These calculated values are in good agreement with the actual cumulative geometrical surface area (A_{geom}, ˜1.25×10⁻² cm²) of one entire μE array used in the present disclosure.

Influence of RE and CE's Relative Placement on NP-μFEC CV

Keeping the WE and CE electrode positions the same and altering the RE's position is observed not to affect the redox behavior as demonstrated by the near-identical voltammograms using the configurations WE/CE_1/RE_1,2,3, as shown in FIG. 2(c). In conventional bulky 3-electrode electrochemical systems, the position of RE relative to the WE is observed to significantly impact the potential drop (iR_{cell}) between the RE and WE. Therefore, positioning the RE close to the WE is recommended in such set-ups for precise control over the WE potential [see references 35, 36 and 37 to Oldham, Savéant and Myland, respectively]. However, in NP-μFEC (non-planar microfluidic electronic cell), no noticeable impact of the RE position alterations relative to WE is observed even when the distance between the RE and WE (d_{rw}) is more significant than 3.0 cm, namely, the RE is located at RE_3 (FIG. 2(a)), suggesting higher electrochemical operational flexibility in NP-μFEC (non-planar microfluidic electrochemical cell).

However, significant changes are observed when the CE's position is progressively offset from the WE, as demonstrated in FIG. 2(b). Upon switching from WE/CE_1/RE_1 to WE/CE_2/RE_1, the current curves show significantly less prominent redox features and a considerable reduction in the overall current intensity. The voltammograms with WE/CE_2,3,4/RE_1 configurations show similar behavior, as shown in FIGS. 10(c) and 10(d). FIGS. 10(a)-10(e) illustrate (a) Schematic diagram of NP-μFEC. (b) CV test results are obtained from pure KCl solution (1M) at different RE positions. (c) CV test results are obtained at different scan rates v based on the WE/CE_3/RE_1 configuration. (d) CV test results are obtained at different scan rates v based on the WE/CE_4/RE_1 configuration. (e) CV test results are obtained at different CE positions, and v equals 30 mV/s. The solution used here is K₃/K₄Fe(CN)₆ (0.01 M) in KCl (1 M).

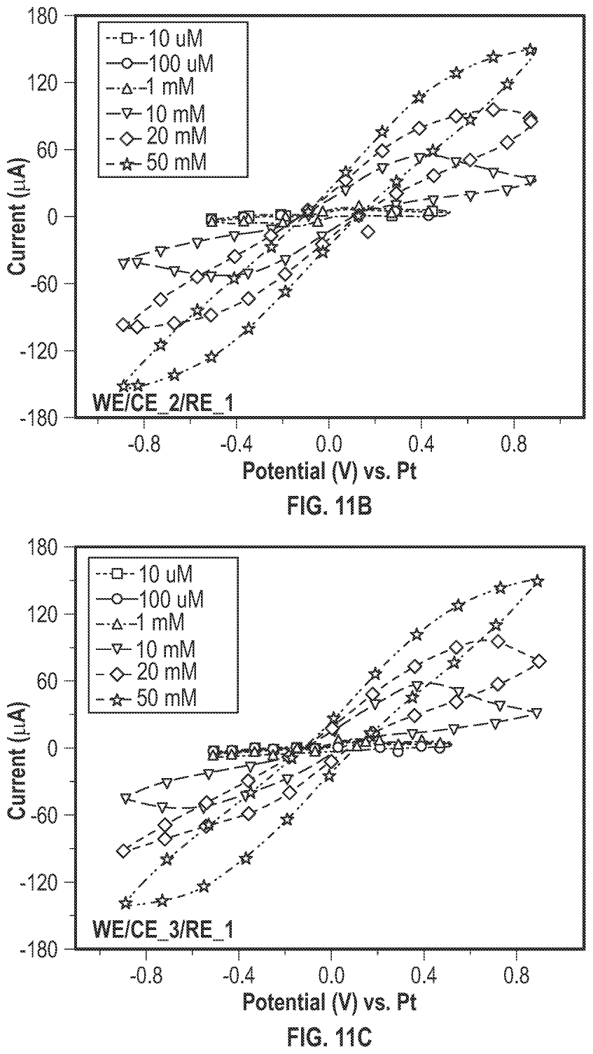

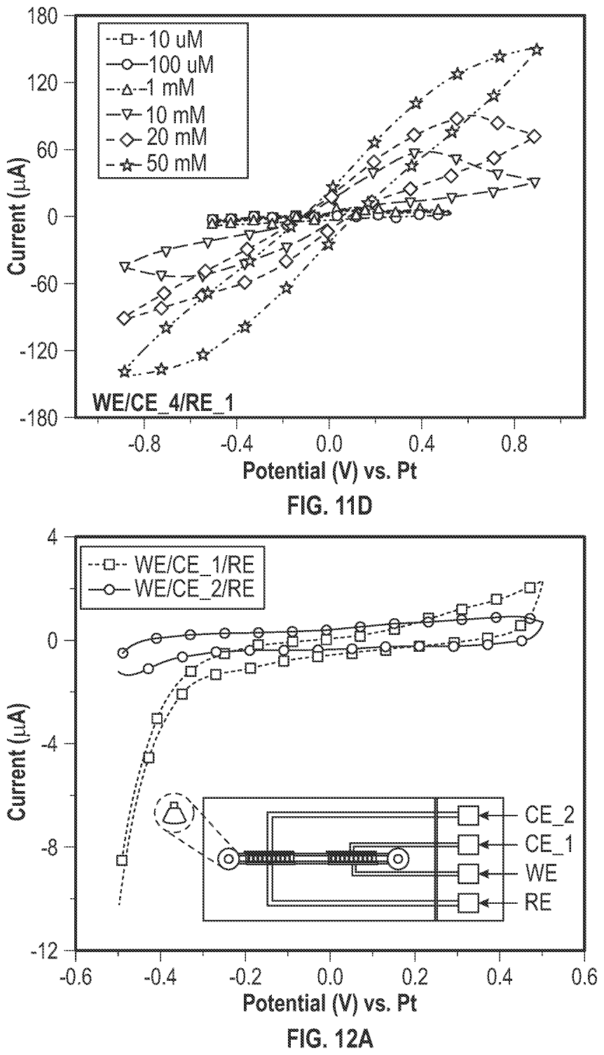

However, with an increase in the scanning range from (+550 mV to −550 mV) to (+900 mV to −900 mV), redox peaks are observed (FIG. 10(e)). FIGS. 11(a)-11(d) shows the CV results obtained at different CE positions. FIGS. 11(a)-11(d). CV test results obtained at different CE positions ((a) WE/CE_1/RE_1; (b) WE/CE_1/RE_1; (c) WE/CE_1/RE_1; (d) WE/CE_1/RE_1). See Table 1. The scan rate is 30 mV/s;

As shown, compared with other configurations, for WE/CE_1/RE_1 (WE and CE are “Interdigitated”), well-defined cyclic voltammograms with relatively narrower ΔEₚ and high peak currents are obtained. However, for WE/CE_2,3,4/RE_1 (WE and CE are “Non-Interdigitated”) with the increase of concentration, massive shifts in peak potentials (Eₚₐ, E_{pc}) are observed and these results in considerable gains in ΔEₚ (see Table 1 below). This usually indicates a high barrier to electron transfer, and electron transfer reactions are sluggish [see reference 32 to Elgrishi]. Hence more negative (positive) potentials are required to observe reduction (oxidation) reactions, giving rise to more significant ΔEₚ.

TABLE 1
Redox features of Fe(CN)₆]^{3-/4-} couple in NP-μFEC at different CE positions.

| Configuration | Concentration | | Eₚₐ (mV) | E_{pc} (mV) | ΔEₚ (mV) | iₚₐ (μA) | i_{pc} (μA) | E^{0′} (mV) |
|---|---|---|---|---|---|---|---|---|
| WE/CE_1/RE_1 | 100 | μM | 60 | −60 | 120 | 1.1 | 1.1 | ~0 |
| | 1 | mM | 60 | −70 | 130 | 9.1 | 10.1 | ~−5 |
| | 10 | mM | 60 | −70 | 130 | 102.8 | 95.5 | ~−5 |
| | 20 | mM | 60 | −60 | 120 | 241.1 | 233.8 | ~0 |
| | 50 | mM | 50 | −70 | 120 | 536.9 | 493.0 | ~−10 |
| WE/CE_2/RE_1 | 100 | μM | 60 | −60 | 120 | 0.83 | 0.98 | ~0 |
| | 1 | mM | 100 | −120 | 220 | 6.2 | 7.5 | ~−10 |
| | 10 | mM | 430 | −450 | 880 | 41.2 | 45.9 | ~−10 |
| | 20 | mM | — | — | — | — | — | — |
| | 50 | mM | — | — | — | — | — | — |
| WE/CE_3/RE_1 | 100 | μM | 30 | −150 | 180 | 0.78 | 0.96 | ~−60 |
| | 1 | mM | 100 | −190 | 290 | 6.4 | 8.2 | ~−45 |
| | 10 | mM | 430 | −640 | 1070 | 43.2 | 45.2 | ~−105 |
| | 20 | mM | — | — | — | — | — | — |
| | 50 | mM | — | — | — | — | — | — |
| WE/CE_4/RE_1 | 100 | μM | 40 | −140 | 180 | 0.78 | 1.07 | ~−50 |
| | 1 | mM | 110 | −180 | 290 | 6.8 | 8.8 | ~−35 |
| | 10 | mM | 430 | −640 | 1070 | 46.2 | 47.6 | ~−105 |
| | 20 | mM | — | — | — | — | — | — |
| | 50 | mM | — | — | — | — | — | — |

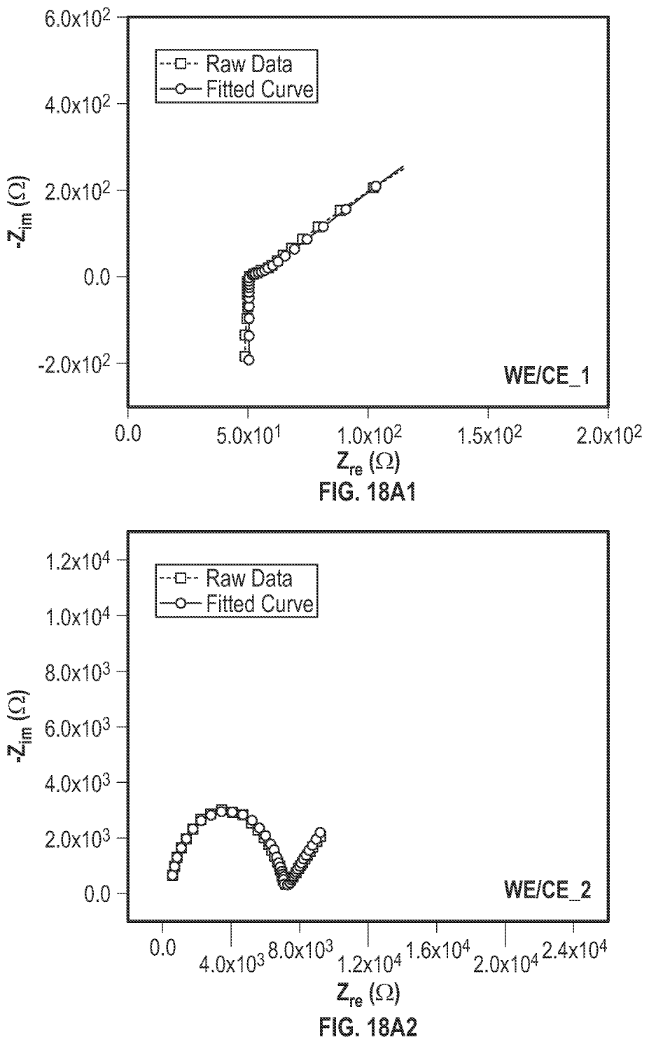

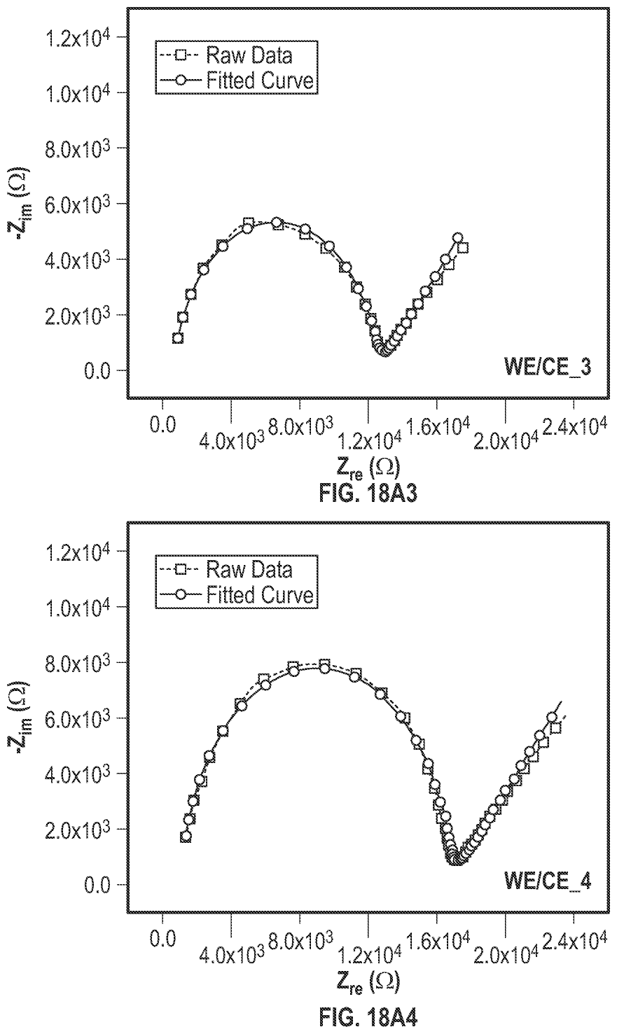

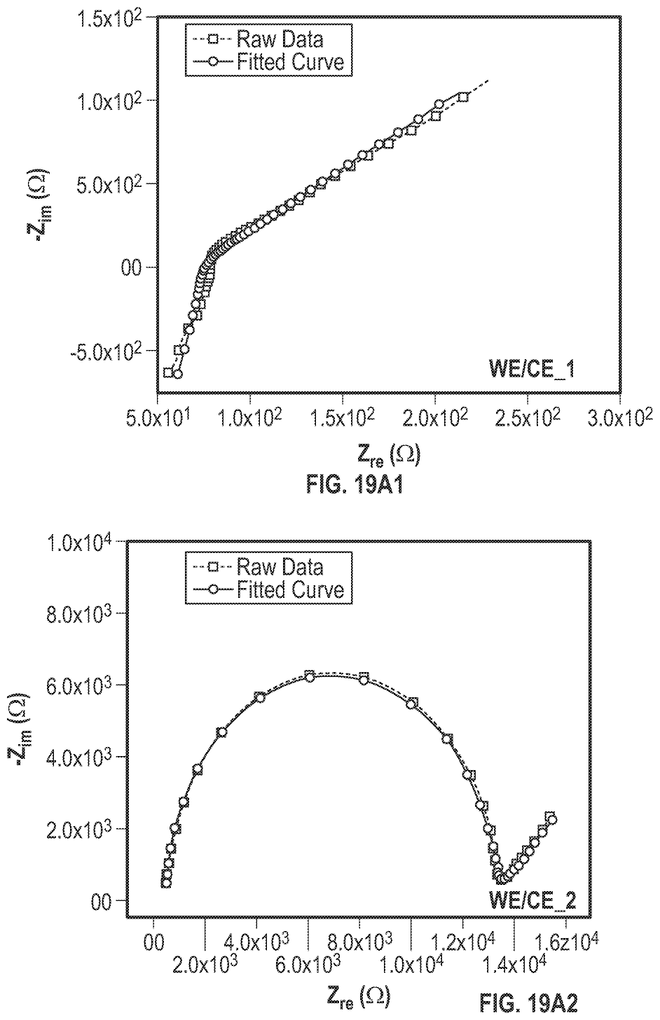

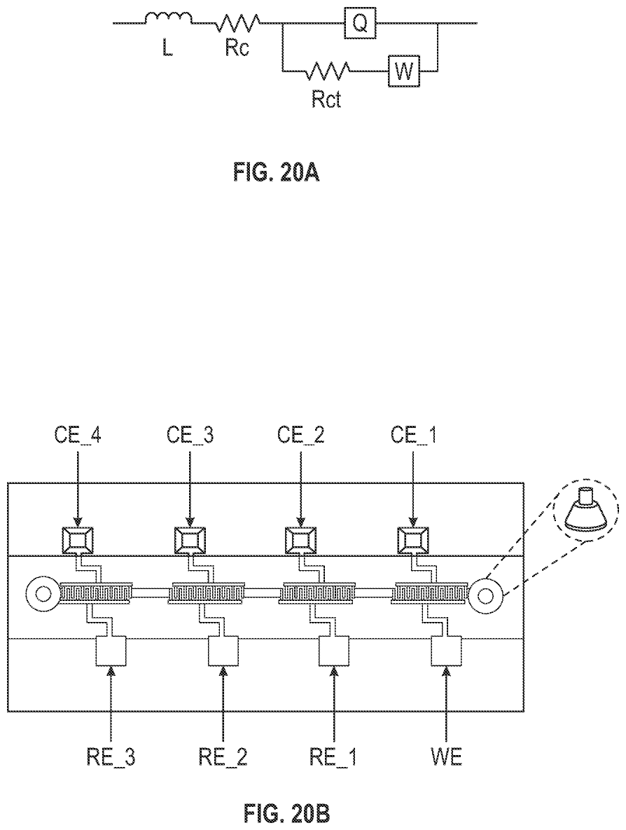

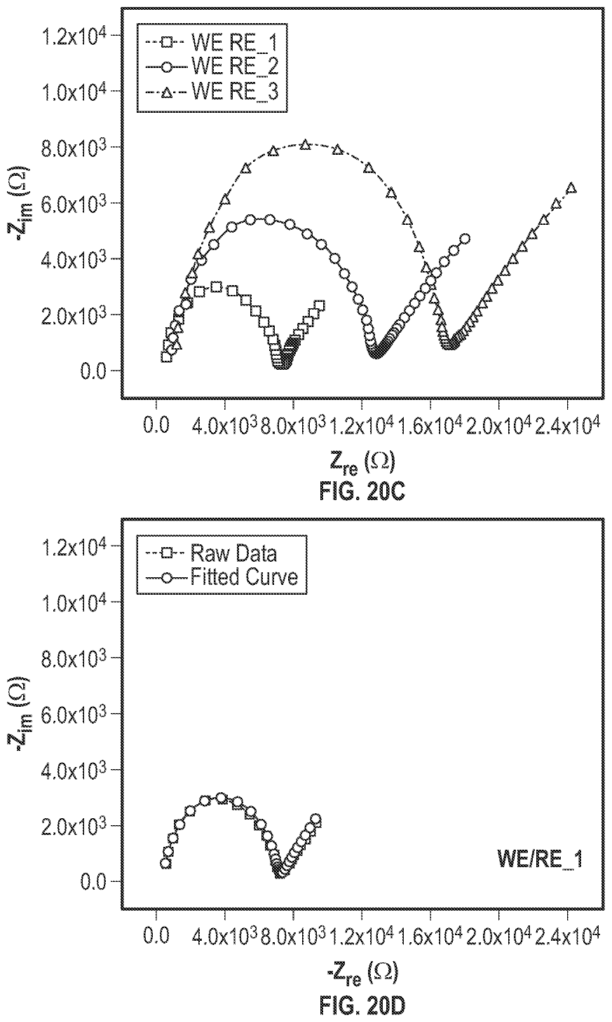

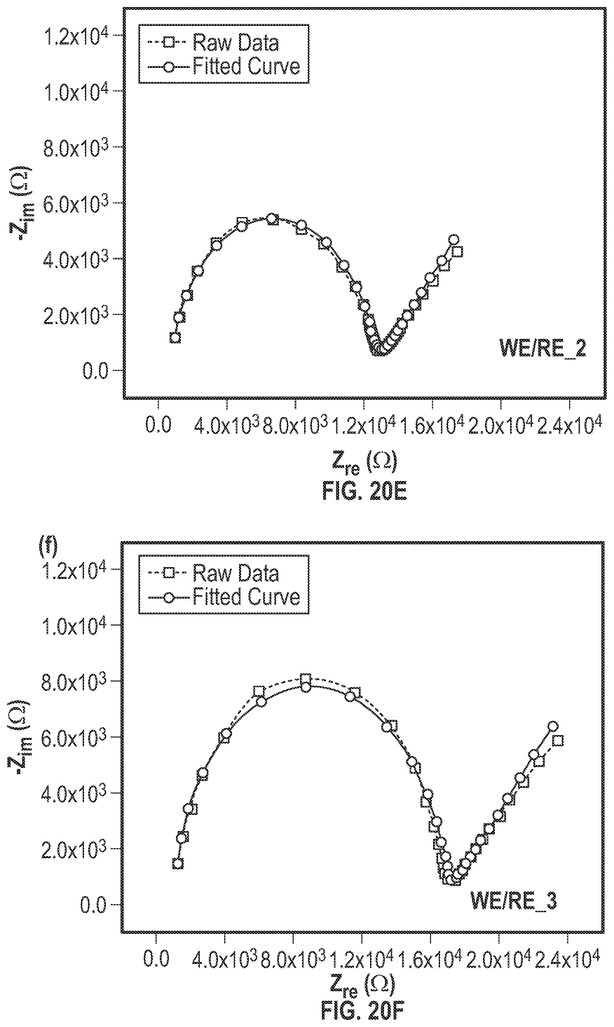

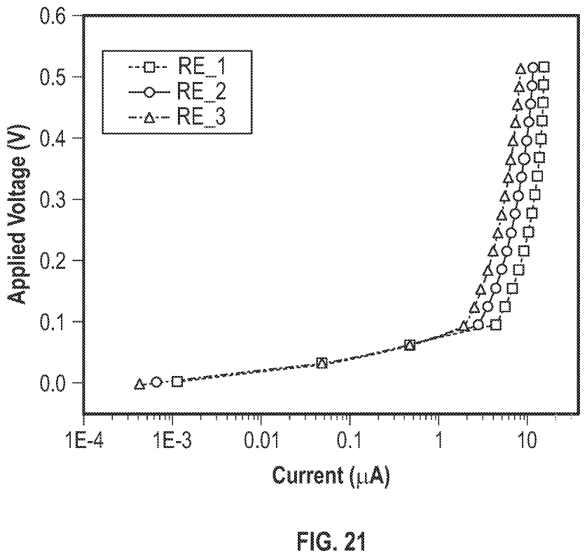

It is hypothesized that there is almost no or negligible change in the ohmic drop iR_{cell} between the RE and WE when the RE changes from RE_1 to RE_3. FIGS. 20(a)-20(f) and 21 show that the ohmic drop between RE_1/2/3 and WE is approximately 5.4 mV, 7.4 mV, and 9.6 mV, respectively. Since there are no apparent changes in the ohmic drop, there are no/minimal changes in the cyclic voltammograms (FIG. 2(c)). However, dramatic changes are observed with the increase of the spacing between the CE and WE (d_{cw}), as exemplified by the loss of the classical “duck-shape” features of cyclic voltammograms. When the CE and WE are increasingly offset, the ohmic drop between the CE and WE significantly increase from −2.8 to 45.6 mV (FIGS. 18(a1)-18(a4)). FIGS. 18(a1)-18(a4) illustrate a Raw Nyquist plot and its corresponding fitted curve when the CE is placed at CE_1,2,3,4 of, respectively. Here, the solution used for the EIS testing is [Fe(CN)₆]^{3-/4-} (0.01 M) in KCl (1 M). Therefore, in a non-planar microfluidic electrochemical cell, the spacing d_{cw} plays a more critical role than the d_{rw} on the non-planar microfluidic electrochemical cell's electrochemical performance.

FIGS. 19(a1)-19(a2) illustrate a raw Nyquist plot and its corresponding fitted curve when the CE is placed at CE_1 and CE_2, respectively. Here, the solution used for the EIS testing is [Fe(CN)₆]^{3-/4-} (0.01 M) in KCl (1 M).

FIGS. 20(a)-20(f) illustrate (a) Equivalent circuit diagram. (b) Schematic diagram of NP-μFEC. (c) Nyquist plots obtained at different RE positions of NP-μFEC. (c) Black and red curves are the raw Nyquist plot and its fitted curve based on the equivalent circuit (a) at RE_1 (d); RE_2 (e); RE_3 (f). The solution used for the EIS testing is [Fe(CN)₆]^{3-/4-} (0.01 M) in KCl (1 M).

FIG. 21 illustrates I-E curves between WE and RE_1,2,3 in the non-planar microfluidic electrochemical cell. The potential difference between the WE and RE_1,2,3 changes from 0 to 500 mV (v=30 mV/s). Here, the solution used for the I-E testing is [Fe(CN)₆]^{3-/4-} (0.01 M) in KCl (1 M);

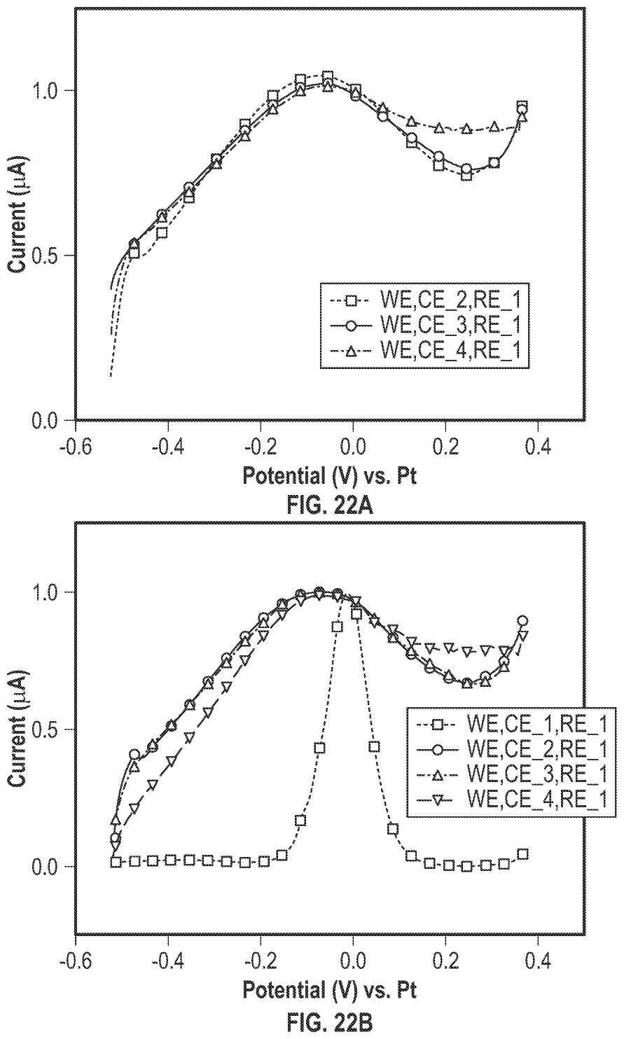

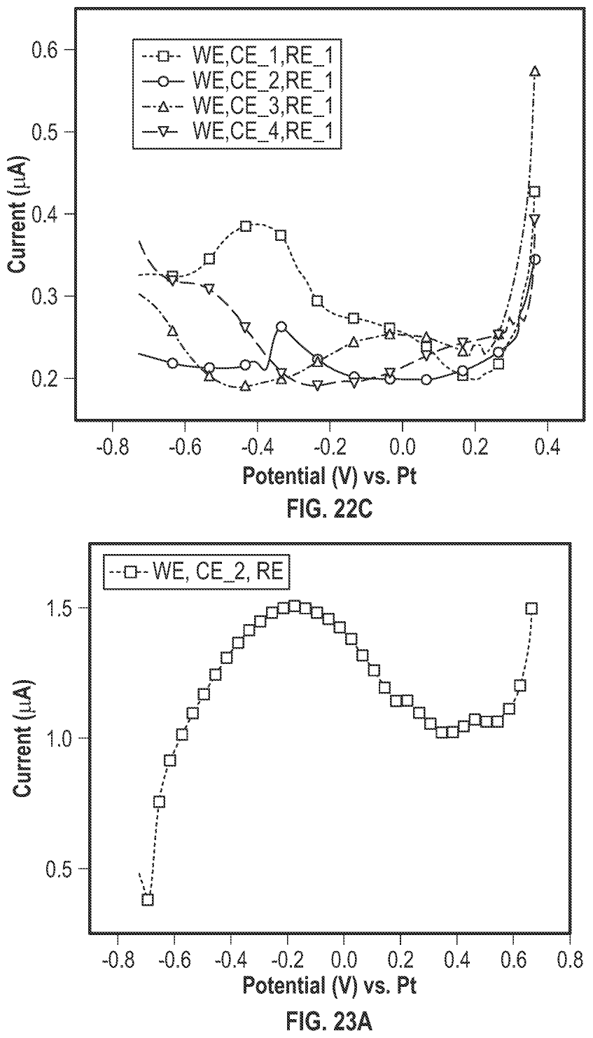

FIGS. 22(a)-22(c) illustrate (a) DPV test results obtained under different electrode connection modes (WE/RE_1/CE_2, WE/RE_1/CE_3, WE/RE_1/CE_4). The solution used here is K₃/K₄Fe(CN)₆ (6×10⁻⁴ M) in KCl (1 M). (b) Normalized DPV profiles obtained from different CE positions. (c) DPV background currents gained from pure KCl solution (1 M) under different electrode connection configurations.

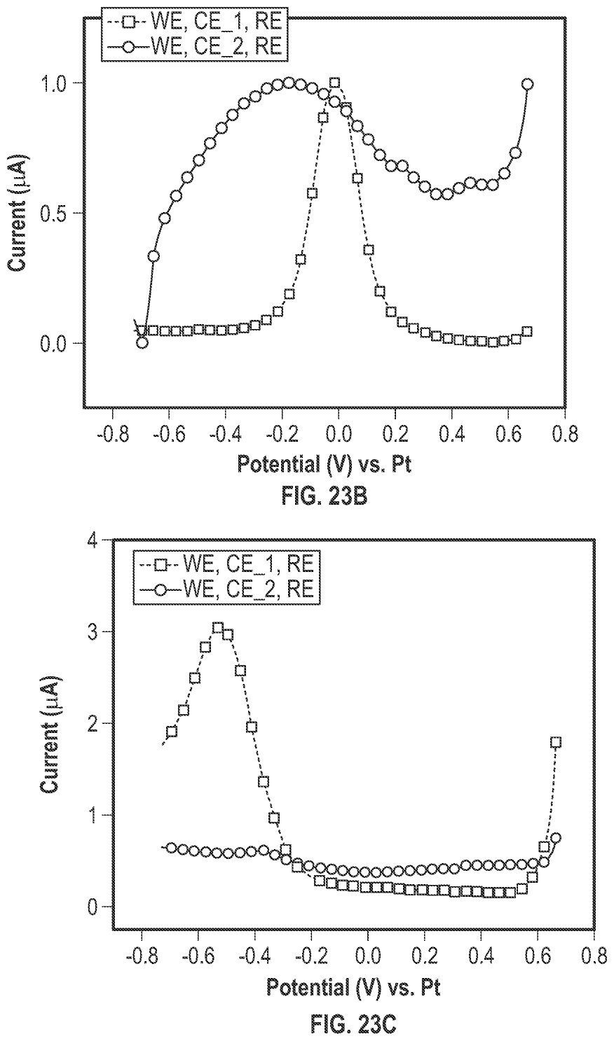

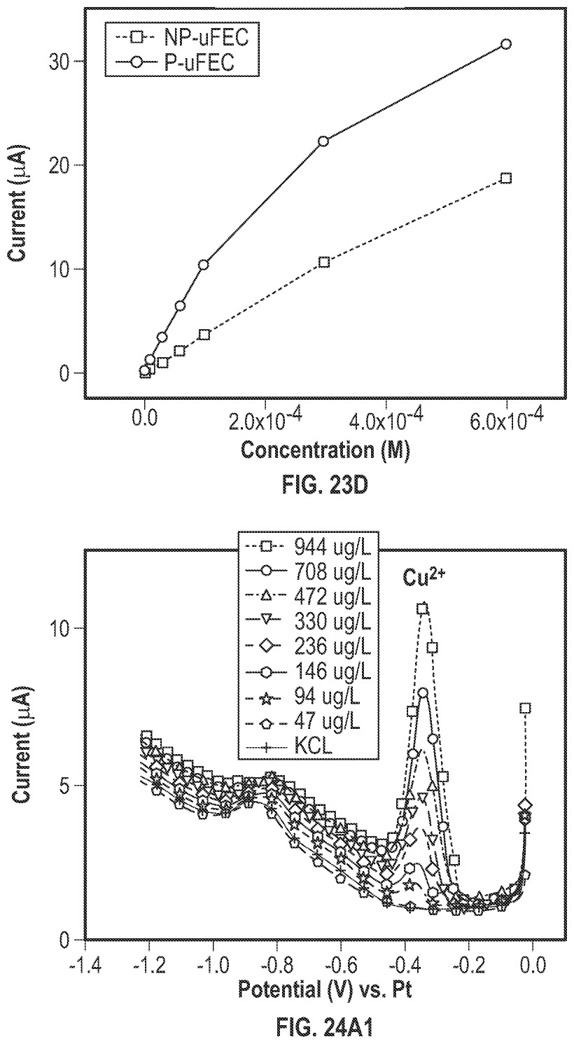

FIGS. 23(a)-23(d) illustrate (a) DPV test results are obtained at CE_2. The solution used here is K₃/K₄Fe(CN)₆ (6×10⁻⁴ M) in KCl (1 M). (b) Normalized DPV profiles are obtained from different CE positions. (c) DPV background currents gained from pure KCl solution (1 M) under different electrode connection configurations. (d) Peak currents extracted from DPV voltammetric curves obtained from different concentrations of the [Fe(CN)₆]^{3-/4-} redox couple in 1 M KCl solutions. The red line comes from the P-μFEC device, and the black line comes from the NP-μFEC device. Both data are acquired based on the WE/CE_1/RE_1 configuration.

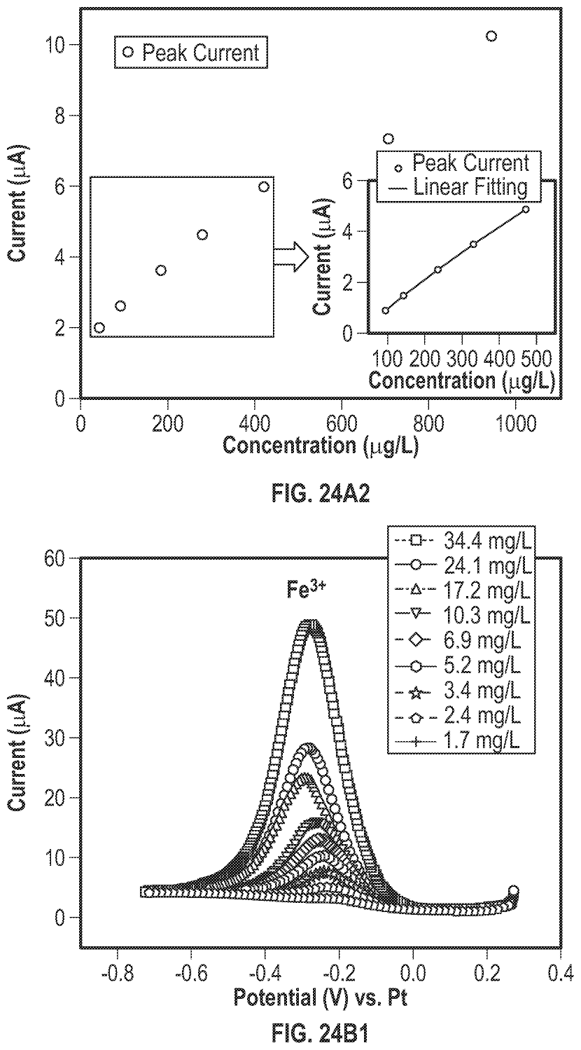

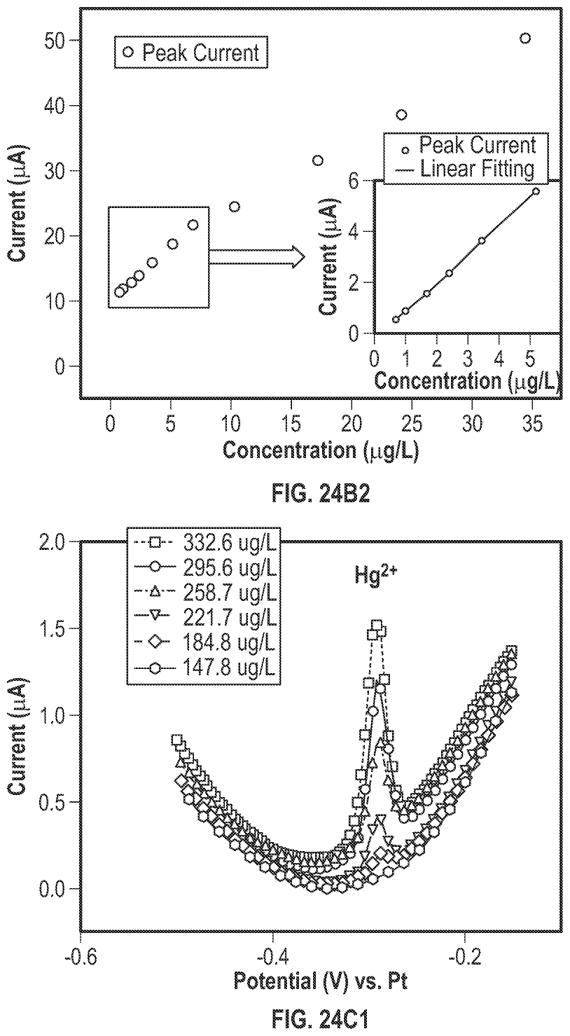

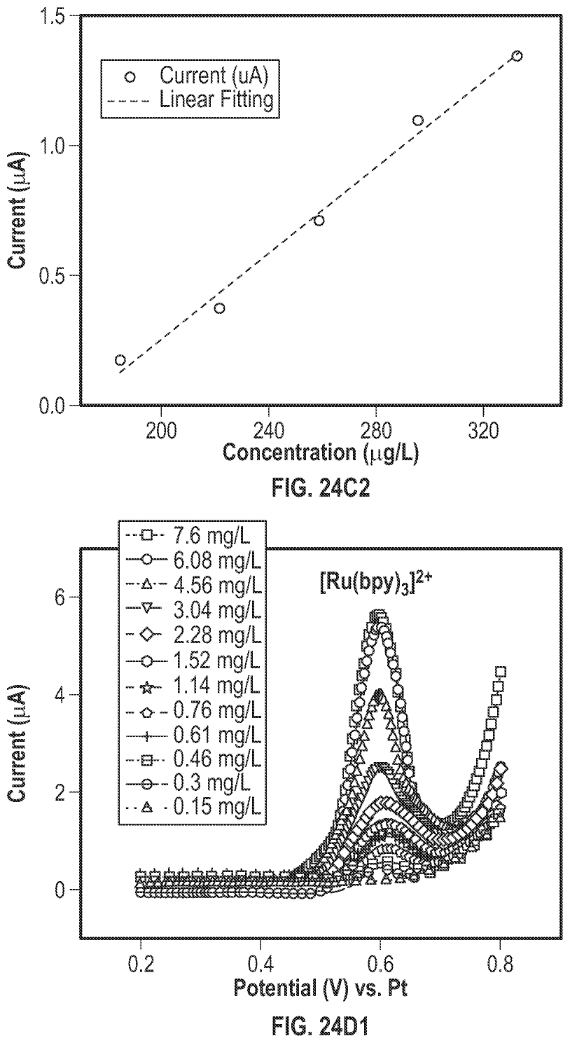

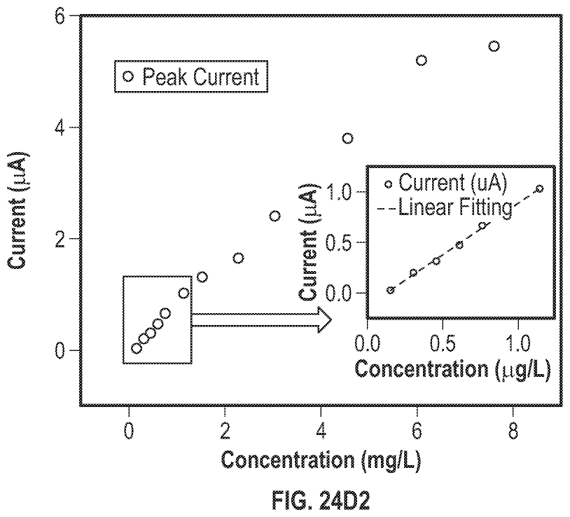

FIGS. 24(a1)-24(d2) illustrate (a1) DPV results obtained using different concentrations of Cu²⁺. (b1) Corresponding peak current vs. the concentrations of Cu²⁺. The equation of linear ranges of 472 μg/L-94.4 μg/L is: I=0.01×Con (μg/L)−0.017; R²=0.9977. Similarly, for Fe³⁺, DPV results are shown in (b1) and (b2). The equation of linear ranges of 5.16 mg/L-0.7 mg/L is: I=1.705×Con (mg/L)−0.467; R²=0.9977. For Hg²⁺, DPV results are shown in (b1) and (b2). The equation of linear ranges of 332.6 μg/L-184.8 m/L is: I=0.008×Con (μg/L)−1.402; R²=0.9871. For the metal compound [Ru(bpy3)2+], DPV results are shown in (d1) and (d2). The equation of linear ranges of 1.14 mg/L-0.152 mg/L is: I=1.01×Con (mg/L)−0.128; R²=0.9968. Here, all the data are acquired based on the WE/CE_1/RE_1 configuration. All the solutions are prepared using 1 M KCl in this embodiment.

Additionally, Table 2 shows the value of circuit elements in the equivalent circuit at different RE positions.

TABLE 2
Value of circuit elements in the equivalent circuit at different RE positions.

| System | CE | L (Henri) | R_{c} (ohm) | Q (S-secⁿ) | n | R_{ct} (ohm) | W (S-sec^{0.5}) | Chi-square |
|---|---|---|---|---|---|---|---|---|
| NP- | RE_1 | 6.227E−7 | 319.2 | 8.232E−12 | 0.9281 | 6729 | 3.546E−6 | 7.29E−5 |
| μFEC | RE_2 | 9.264E−7 | 571.6 | 3.679E−12 | 0.9426 | 11970 | 1.704E−6 | 1.22E−4 |
| | RE_3 | 8.669E−7 | 1033 | 1.301E−12 | 0.9856 | 15660 | 1.249E−6 | 3.46E−4 |

In addition, since the cyclic voltammograms are obtained under the stagnant condition, convective contribution to the overall current density can be ignored. Furthermore, at the high ionic strength liquid of 1M KCl, the contribution of electromigration can also be neglected [see reference 28 to Li]. Hence, mass transport is chiefly dominated by diffusion. With the stepwise movement of CE away from the WE, the diffusional gradient of reagents/products will weaken significantly. This will decrease the current density leading to poor electrochemical performance. These findings suggest that in non-planar microfluidic electrochemical cells, the “interdigitated” layout of the CE and WE is the best option for CV, DPV. This provides us valuable preliminary suggestions on the future design or optimization of the non-planar microfluidic electrochemical cell as an analytical tool.

P-μFEC CV

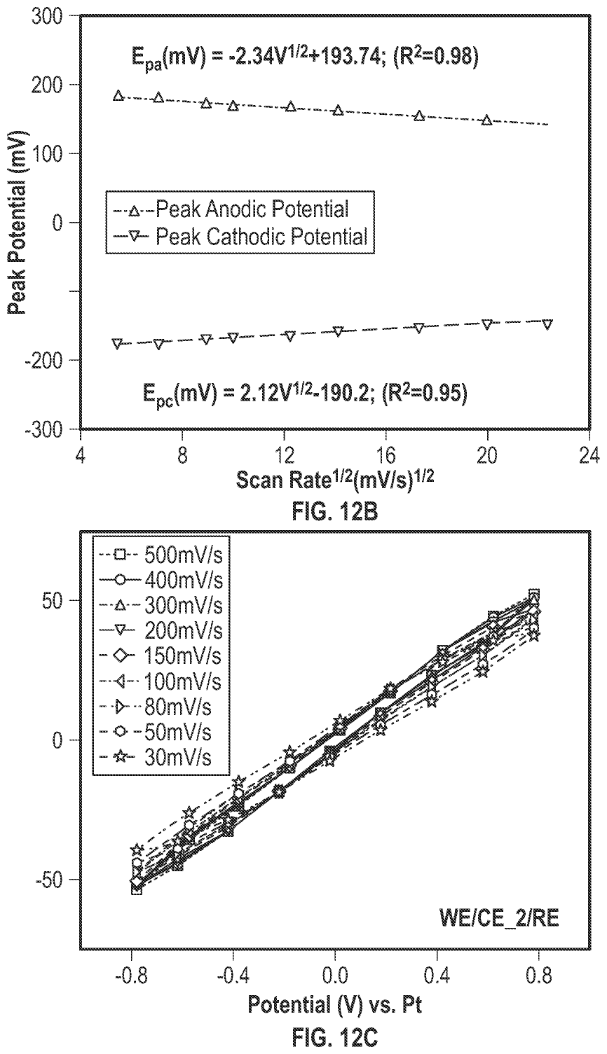

FIG. 2(f) is the schematic diagram of the P-μFEC (planar microfluidic electronic cell) configuration. The voltammetric responses of two different electrode configurations (WE/CE_1/RE and WE/CE_2/RE) are studied and shown in FIGS. 2(g) and (h), respectively. The corresponding background currents obtained from 1M KCl electrolyte are shown in FIG. 12(a).

FIGS. 12(a)-12(c) illustrate CV test results obtained from KCl solution (1 M) at different CE positions. Inset is the picture of the P-μFEC (planar microfluidic electronic cell). The scan rate v is 30 mV/s. (b) Plots of peak potentials (Eₚₐ, E_{pc}) versus the square root of scan rates v^{1/2} (from 30 to 500 mV/s). The equation of the anodic peak potential (Eₚₐ) line: Eₚₐ (mV)=−2.3.4×v^{1/2}+193.74; R²=0.98. The equation of the cathodic peak potential (E_{pc}) line: E_{pc} (mV)=2.12×v^{1/2}−190.2; R²=0.95. (c) CV test results obtained under different scan rates v based on the WE/CE_2/RE configuration. The solution used here is K₃/K₄Fe(CN)₆ (0.01 M) in KCl (1 M).

Influence of RE and CE's Relative Placement on P-μFEC CV

For the WE/CE_1/RE configuration, the i (current) vs. E (applied potential) profile at v=100 mV/s shows a sigmoidal behavior reminiscent of a steady-state electrochemical process characteristic of a predominantly radial diffusion field [see references 23, 28 and 39 to Zhng, Kadara and Hwang, respectively]. In this case, [Fe(CN)₆]^{3-/4-} get reduced/oxidized between the electrode fingers of the WE and CE. This process is sometimes referred to as redox cycling. The redox cycling counteracts the further depletion of [Fe(CN)₆]³⁻ (cathodic sweep) and [Fe(CN)₆]⁴⁻ (anodic sweep) near the WE and results in steady-state current [see reference 28 to Li]. A key observation is that ΔEₚ decreases in magnitude gradually as the v is progressively increased ((ΔEₚ @ v): 360 mV @ 30 mV/s; 330 mV @ 100 mV/s; 280 mV @ 500 mV/s), as shown in FIG. 12(b). This behavior of the P-μFEC (planar microfluidic electronic cell) marks a stark contrast to the NP-μFEC (non-planar microfluidic electronic cell), which shows an opposite trend in the variations of ΔEₚ with v. By contrast, the formal potential E° ′ of [Fe(CN)₆]^{3-/4-} in the P-μFEC (planar microfluidic electronic cell) equals ˜0 mV and therefore mirrors the behavior of NP-μFEC (non-planar microfluidic electronic cell) in being v independent. The effects of v on the peak currents in the cyclic voltammograms are illustrated in FIG. 2(g) inset. The linear relationship between the peak currents (iₚₐ, i_{pc}) and v^{1/2} further confirms a classical Nernstian behavior in P-μFEC (planar microfluidic electronic cell) where diffusion is the rate-limiting step[3]. The Randle-Sevcik Equation (1) can further be used to estimate the cumulative WE surface area, Areal [see reference 31 to Schroll]. The value of Areal estimated using the Randle-Sevcik analyses on the cathodic processes and the anodic processes are equal to 1.14×10⁻² cm² and 1.25×10⁻² cm², respectively. The actual cumulative working electrode surface area A_{geom} equals ca. 1.25×10⁻² cm², consistent with the estimated values.

FIG. 2(h) shows the CV test results obtained at WE/CE_2/RE under different scan rates. Significantly less prominent redox features and reduced current intensities are observed when the CE is fixed at CE_2. This phenomenon is further confirmed in a wider potential window (+800 mV to −800 mV), shown in FIG. 12(c). By comparing the results in FIG. 2(b2) and (b3), it is also found that in the P-μFEC (planar microfluidic electronic cell), when the spacing d_{cw} is decreased to −10 μm, that is, the distance between adjacent WE and CE finger, well-defined CV curves appear. This finding further confirms the previous assumption that for both P-IDμE and NP-IDμE (planar and notn-planar) based μFEC (microfluidic electrochemical cells), the spacing d_{cw} plays a more critical role in the final electrochemical performance.

Np-μFEC Vs. P-μFEC

Based on the analysis above, the difference in the electrochemical characteristics between the NP-μFEC (non-planar microfluidic electronic cell) of the present disclosure and a conventional P-μFEC (planar microfluidic electronic cell) (when the CE and WE are “Interdigitated”) is:
(i) Different electrochemical processes: NP-μFEC (non-planar microfluidic electronic cell) demonstrates a semi-infinite linear diffusion, while the P-μFEC (planar microfluidic electronic cell) shows radial diffusion. However, the semi-infinite linear diffusion enables NP-μFEC one significant benefit: it can easily interrogate the valuable information related to redox processes (like Eₚₐ; E_{pc}; Iₚₐ; I_{pc}), while for P-μFEC is challenging.
(ii) Different peak-to-peak separation (ΔEₚ) behavior: Interestingly, for both NP-μFEC and P-μFEC, ΔEₚ changes slightly with v. It is hypothesized that this deviation could be due to slow electron transfer to the microelectrodes [see reference 31 to Schroll]. However, for NP-μFEC, ΔEₚ increases with v, while for P-μFEC, ΔEₚ decreases with v. See Table 3 see below, it is found that for NP-μFEC, the overall intensity in ΔEₚ is much smaller than that of the P-μFEC. This relatively narrower ΔEₚ means a higher charge-transfer ability is observed in the non-planar configuration [see reference 40 to Yang].

TABLE 3
Redox features of Fe(CN)₆]^{3-/4-} couple in NP-μFEC and P-μFEC under different scan rates.

| | NP-μFEC | | | P- μFEC | | |
|---|---|---|---|---|---|---|
| | Peak to peak | | | Peak to peak | | |
| | separation | Peak Current | Formal | separation | Peak Current | Formal |
| Scan Rate | Eₚₐ − E_{pc} = ΔEp | Ratio abs | Potential | Eₚₐ − E_{pc} = ΔEp | Ratio abs | Potential |
| V (mV/s) | (mV) | (i_{pc}/iₚₐ) | E^{0′} (mV) | (mV) | (i_{pc}/iₚₐ) | E^{0′} (mV) |
| 30 | 60 − (−65) = | 110/115 = | ~−3 | 180 − (−180) = | 300/300 = | ~+1 |
| | 125 | 0.96 | | 360 | 1.0 | |
| 50 | 65 − (−70) = | 130/135 = | ~−3 | 180 − (−170) = | 300/300 = | ~+2 |
| | 135 | 0.96 | | 350 | 1.0 | |
| 80 | 70 − (−75) = | 150/170 = | ~−3 | 170 − (−170) = | 310/310 = | ~+1 |
| | 145 | 0.94 | | 340 | 1.0 | |
| 100 | 75 − (−75) = | 165/180 = | ~0 | 170 − (−160) = | 310/310 = | ~−1 |
| | 150 | 0.94 | | 330 | 1.0 | |
| 150 | 85 − (−85) = | 185/199 = | ~0 | 160 − (−160) = | 320/310 = | ~+1 |
| | 170 | 0.92 | | 320 | 1.03 | |
| 200 | 90 − (−85) = | 205/220 = | ~+3 | 160 − (−150) = | 320/310 = | ~+2 |
| | 175 | 0.93 | | 310 | 1.03 | |
| 300 | 100 − (−100) = | 240/240 = | ~0 | 150 − (−150) = | 330/310 = | ~+1 |
| | 200 | 1.0 | | 300 | 1.06 | |
| 400 | 110 − (−100) = | 260/260 = | ~+5 | 150 − (−140) = | 340/330 = | ~+1 |
| | 210 | 1.0 | | 290 | 1.03 | |
| 500 | 110 − (−110) = | 270/280 = | ~0 | 140 − (−140) = | 350/340 = | ~−3 |
| | 220 | 0.96 | | 280 | 1.03 | |

COMSOL Multiphysics Simulation

For both planar and non-planar μFECs (microfluidic electrochemical cells), to see changes in the electric fields as the CE and WE are more and more off-set from each other and compare the difference in the electric field distribution in the NP-μFEC (non-planar microfluidic electronic cell) and P-μFEC (planar microfluidic electronic cell). Detailed FEA using COMSOL Multiphysics 5.5. are carried out to determine the actual electric field distribution within the 3D NP-μFEC vs. 2D P-μFEC. In addition, FEA is also employed to see the influence of the transition in μE arrays (from coplanar to non-planar interdigitated structure) on the distribution of concentration profiles of aqueous [Fe(CN)₆]^{3-/4-} couple.

TABLE 4
Parameter setting for COMSOL simulation.

| Parameter | Value | |
|---|---|---|
| Electrode Height (E_{H}) | 0.1 | μm |
| Electrode Width (E_{W}) | 10 | μm |
| Solution Electrical Conductivity | ~9 | S/m |
| Solution Relative Conductivity | 80 | |
| Glass Substrate Electrical Conductivity | 1 × 10⁻¹⁵ | S/m |
| Glass Substrate Relative Permittivity | 4.68 | |
| P-μFEC Double Layer Capacitance | ~2.6 × 10⁻⁶ | F |
| NP-μFEC Double Layer Capacitance | ~1.6 × 10⁻⁶ | F |

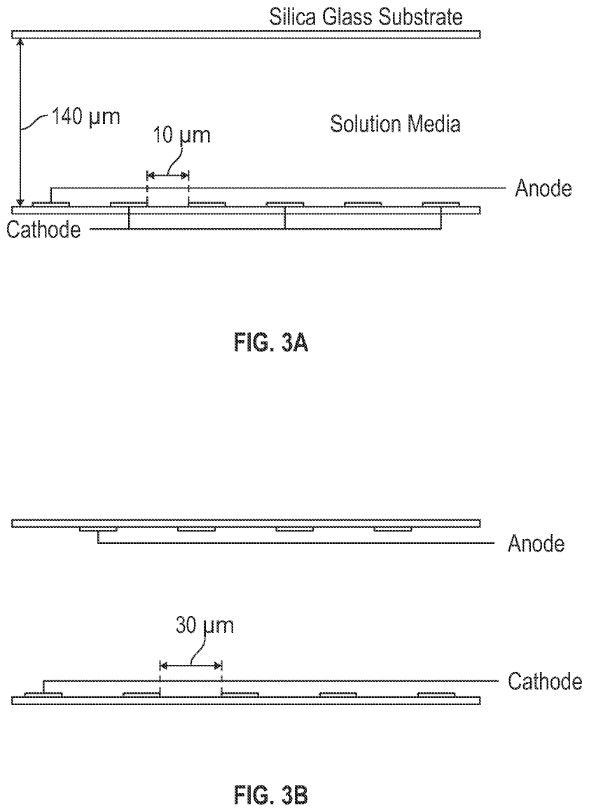

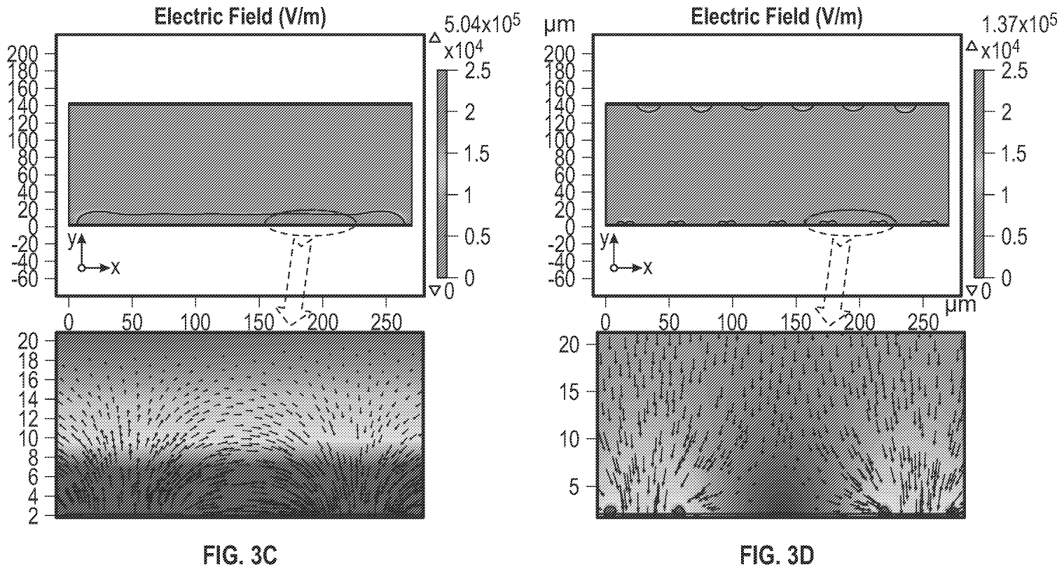

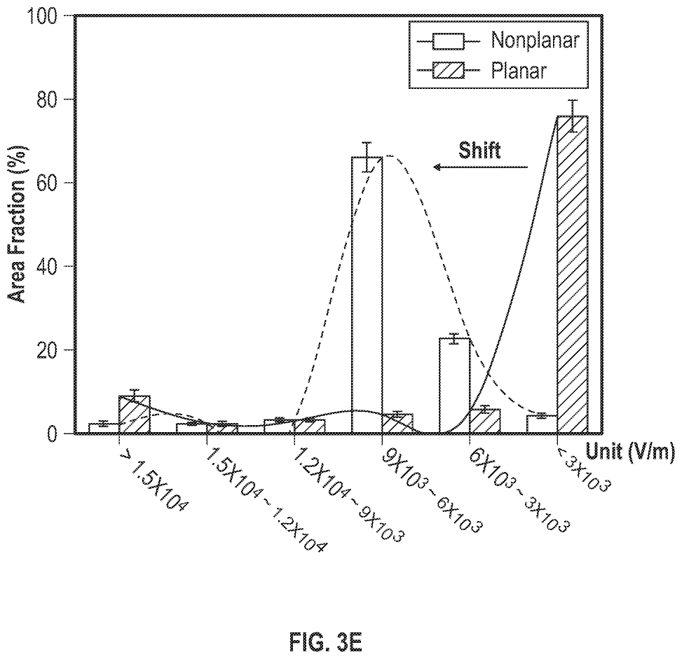

Table 4 summarizes the simulation parameters. The effect of double-layer capacitance is considered in the COMSOL simulation. Additionally, relevant double-layer capacitance values are obtained based on the subsequent EIS results (Tables 6 and 7). To avoid long pre-processing, solving, and post-processing periods, the geometries of the P-μFEC (planar microfluidic electronic cell) and NP-μFEC (non-planar microfluidic electronic cell) are simplified to a representative 2D model, as shown in FIGS. 3(a) and 3(b) [see reference 41 to Kostal]. Besides, the periodic distribution characteristics further reduce the model to a few representative pairs of electrode fingers. The gap (E_{G}) of the planar IDμE arrays is set to 10 μm, while the E_{G} of non-planar IDμE arrays is set to 30 μm to ensure a consistent number of electrode fingers per unit length in these two electrode structures. During the CV scanning process (v=30 mV/s), a potential drop from around +1.3 to −0.75V is observed between the WE and CE_1 in the NP-μFEC. Therefore, for the electric field simulation in the NP-μFEC, a varying voltage from +1.3 V to −0.75V is applied to the top μE array while the counterpart bottom μE array is 0 V versus Pt.

Similarly, for the P-μFEC (planar microfluidic electronic cell), the adjacent interdigitated electrode fingers have terminal potentials of from +1.15 V to −0.54 V with a ground potential of 0 V. Of note, for the time-dependent applied voltages, the electric field distribution in the P-μFEC and NP-μFEC at a potential drop of +1.0 V is taken as an example. The electric field distribution is recorded and plotted across the whole microfluidic channel, as FIGS. 3(c)-3(e) demonstrate.

FIG. 3. illustrates the μE configuration of (a) P-μFEC (planar microfluidic electronic cell) and (b) NP-μFEC (non-planar microfluidic electronic cell) (cross-section). Simulated electric field distribution within P-μFEC (c) and NP-μFEC (d) channel. Insets shows the magnified electric field lines in the selected regions. (e) Distribution of the effective area fractions with different I_{EF} intervals within P-μFEC and NP-μFEC channels. Dash (Non-planar) and solid (Planar) represent the corresponded fitted curves.

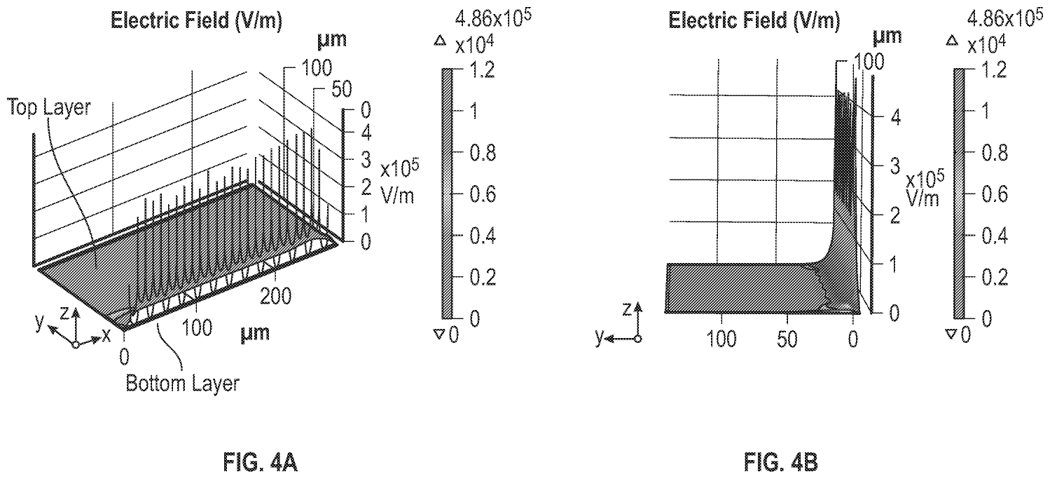

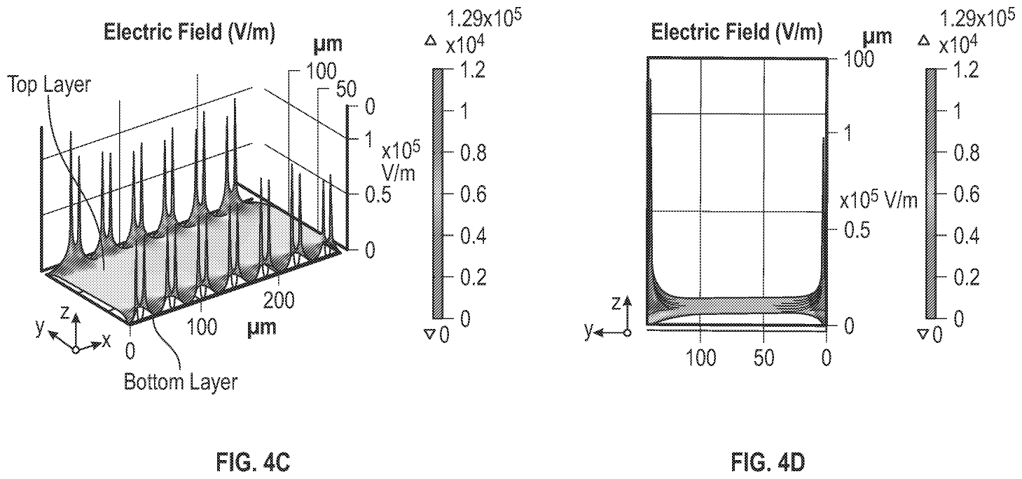

FIG. 4 shows the corresponding spatial distribution of the electric field in the P-μFEC and NP-μFEC.

P-μFEC COMSOL

From the simulation results, the P-μFEC (planar microfluidic electronic cell) and NP-μFEC (non-planar microfluidic electronic cell) display different electric field distributions. For the P-μFEC, the electric field is chiefly concentrated near the electrode surface, as shown in FIGS. 3(c), 4(a) and 4(b). Higher electric field intensity (I_{EF}) is observed at the edges of electrode fingers because sharp edges have a small area that produces a large charge density [see reference 42 to Ismail]. FIG. 3(c) directly shows us the penetration of the electric field (in the y-axis) is around 20 μm in the P-μFEC, which perfectly matches the value of E_{W} (10 μm)+E_{G} (10 μm) and is consistent with the literature [see references 11, 43 and 44 to Van Singh, Van Gerwen and Bratov, respectively]. A radial distributed electric field is observed from the local magnification diagram of FIG. 3(c). However, most regions within the microfluidic channel layer show almost negligible I_{EF}.

NP-μFEC COMSOL

For the NP-μFEC (non-planar microfluidic electronic cell), the μE arrays' spatial orientation lets the opposite electric field penetrate each other. Furthermore, the electric field is no longer confined to the μE surface (FIGS. 3(d), 4(c), and 4(d). Instead of seeing a radial distributed electric field, a vertical spread electric field appears in NP-μFEC (non-planar microfluidic electronic cell). As a result, a more uniformly distributed electric field with enhanced intensity across the entire microfluidic channel volume is observed, which benefits NP-μFEC (non-planar microfluidic electronic cell) a higher sensitivity as an impedance sensor than the planar counterpart [see reference 45 to Cheng].

NP-IDμE Vs. P-IDμE

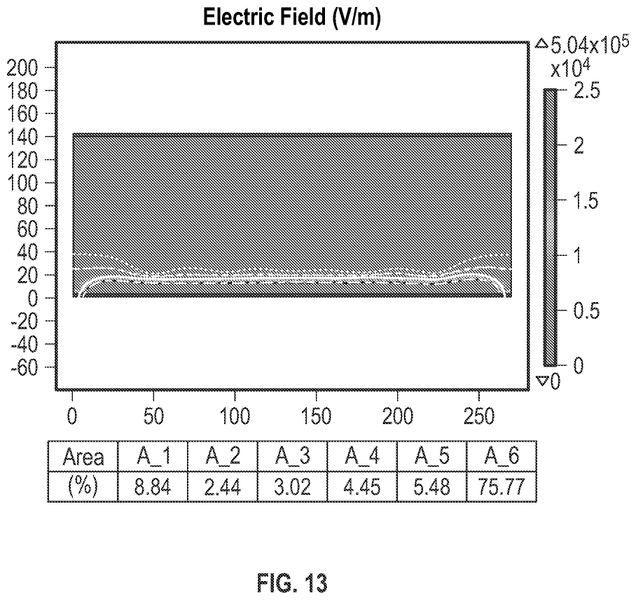

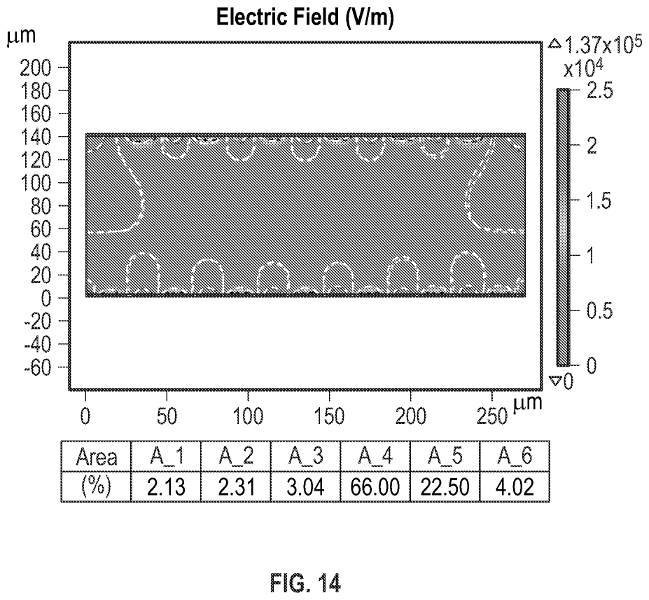

The channel layer of the P-μFEC (planar microfluidic electronic cell) and NP-μFEC (non-planar microfluidic electronic cell) have been divided into six regions with different I_{EF} intervals to facilitate analysis and comparison between them (FIG. 3(e)). The locations of these six regions with different I_{EF} intervals in the P-μFEC and NP-μFEC are shown in FIGS. 13 and 14, respectively. Table 5 below summarizes their corresponding cross-section area fractions. It is found that the P-μFEC has more channel area falling in a relatively stronger electric field range (>1.5×10⁴ V/m) than that in the NP-μFEC. However, most of the channel layer (˜75.77%) has a weak electric field strength (<3×10³ V/m). For the NP-μFEC, most of the channel (˜66.00%) falls in a moderate electric field intensity region (from 9×10³ to 6×10³ V/m).

In FIG. 13, the area within the black dotted line has an electric field intensity (I_{EF}) greater than 1.5×10⁴ V/m. Its cross-section area fraction (A_1) is around 8.84%. The area between the black and yellow dotted lines has an I_{EF} located between [1.5×10⁴-1.2×10⁴ V/m]. Its cross-section area (A_2) fraction is ˜2.44%. Similarly, the area between the yellow and red dotted lines, the region between red and white dotted lines, as well as the area between white and green dotted lines has an I_{EF} falls in [1.2×10⁴-9×10³ V/m], [9×10³-6×10³ V/m], and [6×10³-3×10³ V/m], respectively. Their corresponding cross-section area fraction is around 3.02% (A_3), 4.45% (A_4), and 5.48% (A_5), respectively. The remaining region's I_{EF} is smaller than 3×10³ V/m, and the proportion of the cross-sectional area is around 75.77%.

In FIG. 14. the area within the black dotted line has an electric field intensity (I_{EF}) greater than 1.5×10⁴ V/m. Its cross-section area fraction (A_1) is around 2.13%. The area between the black and yellow dotted lines has an I_{EF} located between [1.5×10⁴-1.2×10⁴ V/m]. Its cross-section area (A_2) fraction is ˜2.31%. Similarly, the area between the yellow and red dotted lines, the region between red and white dotted lines, as well as the area between white and green dotted lines has an I_{EF} falls in [1.2×10⁴-9×10³ V/m], [9×10³-6×10³ V/m], and [6×10³-3×10³ V/m], respectively. Their corresponding cross-section area fraction is around 3.04% (A_3), 66.00% (A_4), and 22.50% (A_5), respectively. The remaining region's I_{EF} is smaller than 3×10³ V/m, and the proportion of the cross-sectional area is around 4.02%;

TABLE 5
Area fractions of different electric field intensity
intervals in P-μFEC and NP-μFEC.

| | | 1.5 × 10⁴ | 1.2 × 10⁴ | 9 × 10³ | 6 × 10³ | |
|---|---|---|---|---|---|---|
| | >1.5 × | to 1.2 × | to 9 × | to 6 × | to 3 × | <3 × |
| I_{EF} (V/m) | 10⁴ | 10⁴ | 10³ | 10³ | 10³ | 10³ |
| P-μFEC (%) | 8.84 | 2.44 | 3.02 | 4.45 | 5.48 | 75.77 |
| NP-μFEC | 2.13 | 2.31 | 3.04 | 66.00 | 22.50 | 4.02 |
| (%) | | | | | | |

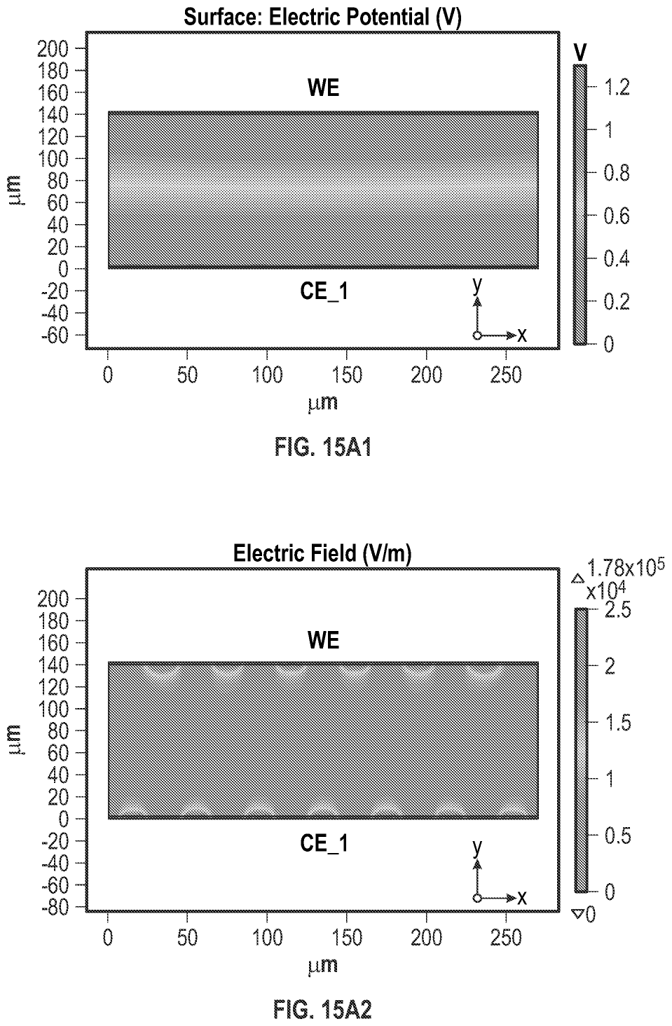

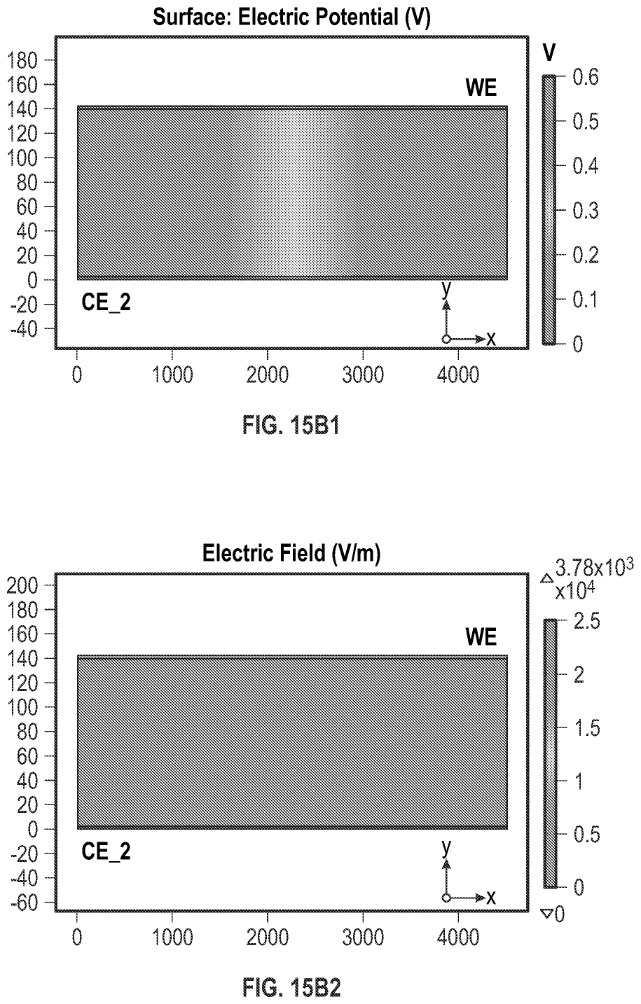

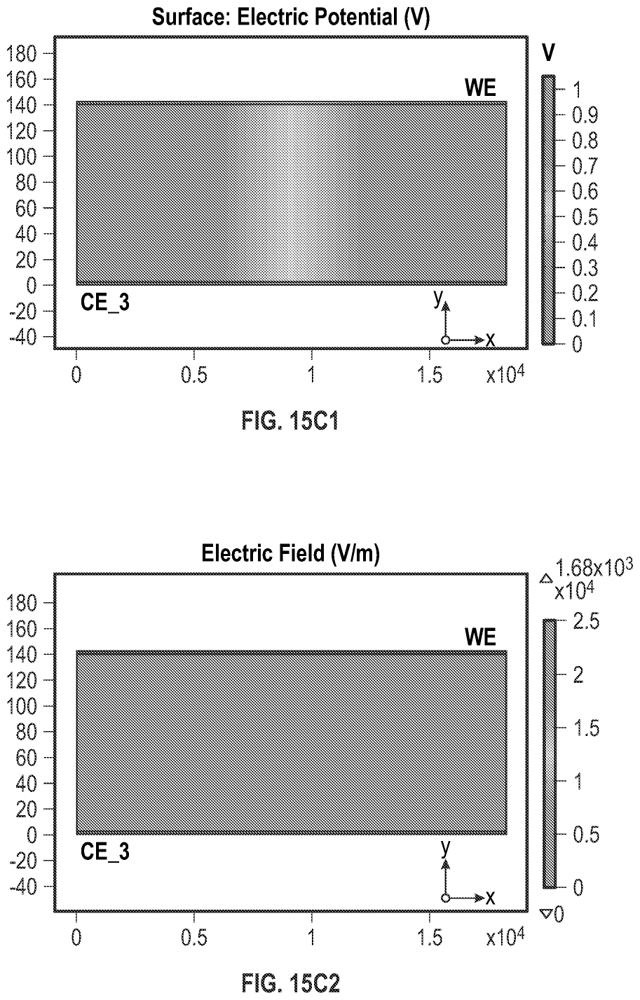

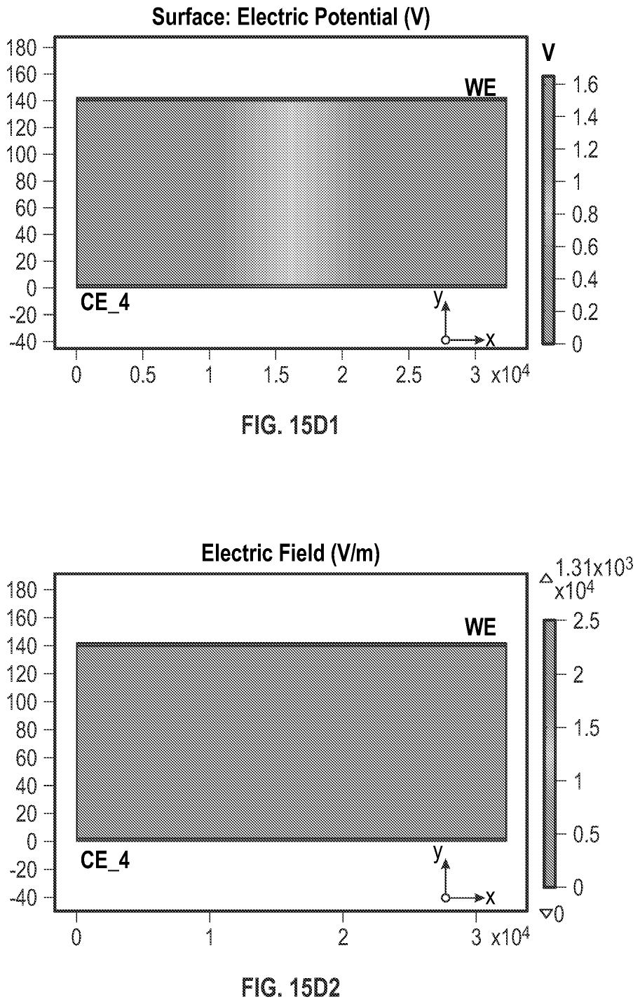

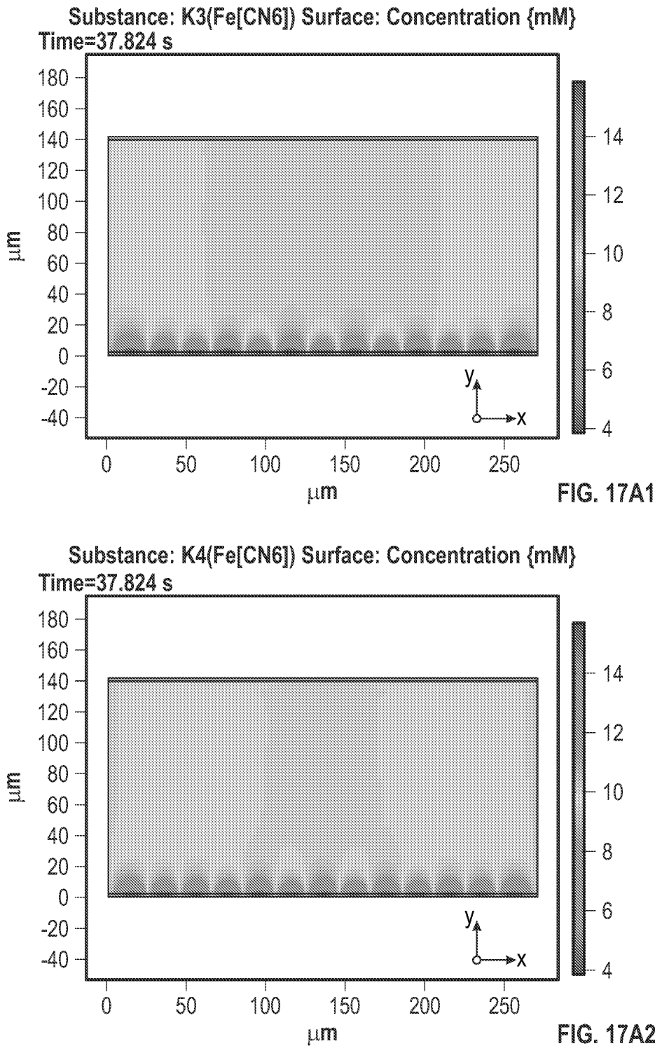

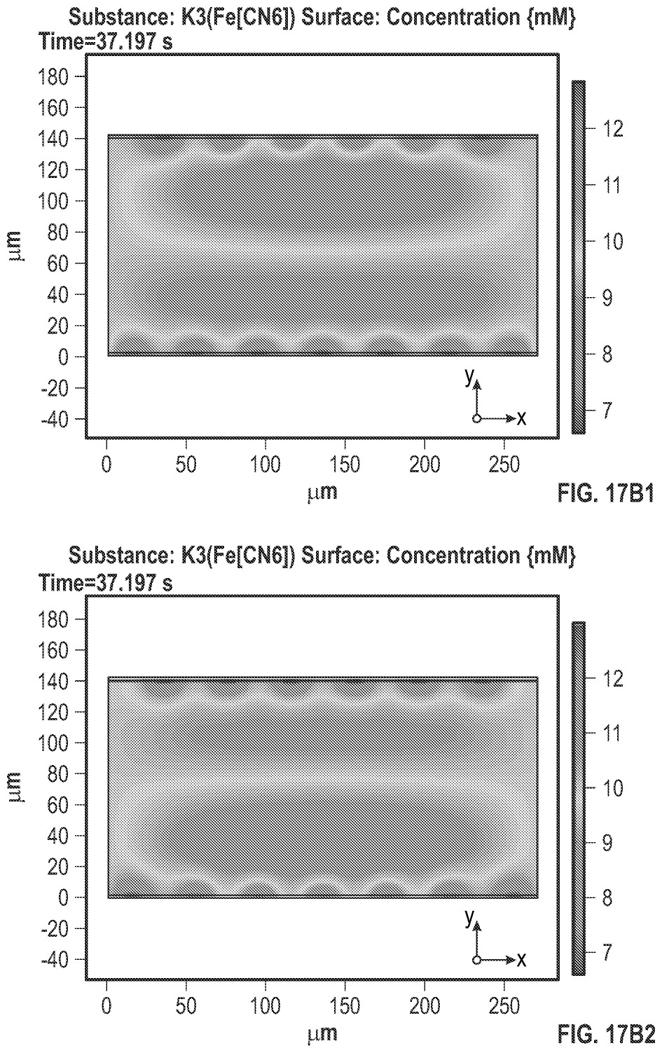

This FEA study directly shows us that the transition of μE arrays from coplanar distribution to non-planar distribution will “drag” a significant part of the electric field away from the μE surface to the bulk channel, as shown in FIG. 3(e). It is also observed that with the stepwise separation between the CE and WE, the electric fields in both the P-μFEC (planar microfluidic electronic cell) and NP-μFEC (non-planar microfluidic electronic cell) undergo a severe attenuation, as shown in FIGS. 15(a1)-15(d2) and 16(a1)-16(b2). The time-dependent mass transport simulation across the channel of NP-μFEC and P-μFEC are conducted using Butler-Volmer electrode kinetics (FIGS. 17(a1)-17(b2)). Based on the simulated concentration profiles, it is observed that redox cycling is seen in P-μFEC, while linear diffusion process is seen in NP-μFEC. These findings are in consistent with observed in the CV results.

In FIGS. 15(a1)-15(d2), (x1) and (x2) represent the applied potential and corresponding electric field distribution in the NP-μFEC (non-planar microfluidic electronic cell), respectively. Here, in FIGS. 15(a) to 15(d) the CE is located at CE_1, CE_2, CE_3, CE_4, respectively. During the CV scanning process (v=30 mV/s), a potential drop from −0.75 to +1.3 V is observed between the WE and CE_1. The electric field distribution with a potential drop of +1.3V is recorded and shown in FIGS. 15(a1) and 15(a2). Similarly, for the configurations of WE/CE_2,3,4/RE_1, a potential drop from −0.55 to +0.6 V, −1.05 to +1.05 V, −1.65 to +1.65 V is observed, respectively. For WE/CE_2/RE_1, a potential drop of +0.6V between WE and CE_2 is applied, and the corresponding electric field distribution is shown in FIG. 15(b2). For WE/CE_3/RE_1, a potential drop of +1.05V between WE and CE_3 is applied, and the corresponding electric field distribution is shown in figure (c2). For WE/CE_4/RE_1, a potential drop of +1.65V between WE and CE_4 is applied, and the corresponding electric field distribution is shown in figure (d2).

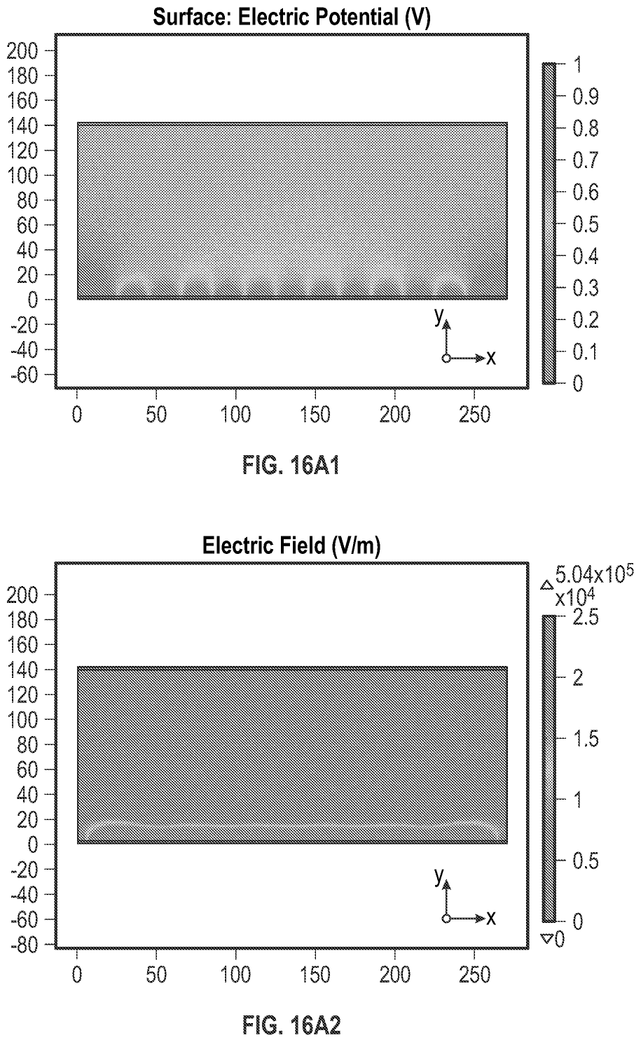

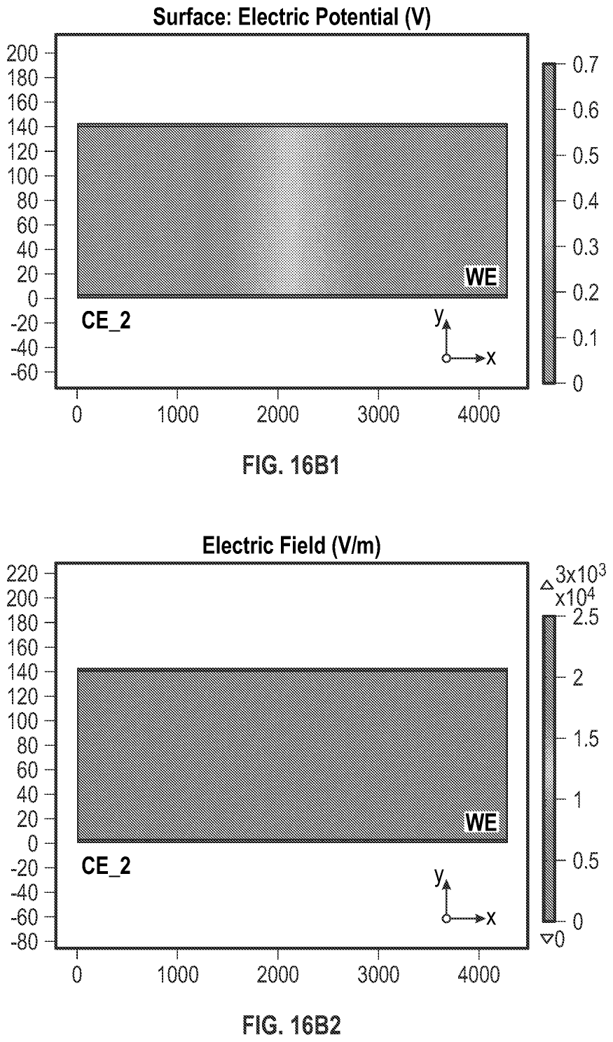

In FIGS. 16(a1)-16(b2), the CE is located at CE_1, CE_2, respectively. During the CV scanning process (v=30 mV/s), a potential drop from −0.54 to +1.15 V is observed between the WE and CE_1. The electric field distribution with a potential drop of +1.1V is recorded and shown in figures (a1) and (a2). Similarly, for the WE/CE_2/RE configuration, a potential drop from −0.65 to +0.87 V is observed between the WE and CE_2. Furthermore, its corresponding electric field distribution with a potential drop of +0.87V is recorded and shown in figures (b1) and (b2).

FIGS. 17(a1)-17(b2) represent the concentration distribution of K₃Fe(CN)₆ and K₄Fe(CN)₆ within the channel of P-μFEC, respectively. (b1) and (b2) represent the concentration distribution of K₃Fe(CN)₆ and K₄Fe(CN)₆ within the channel of NP-μFEC, respectively. Here, the concentration of K₃Fe(CN)₆ and K₄Fe(CN)₆ is set at 10 mM

EIS Characterization

As analyzed above, whether in the P-μFEC (planar microfluidic electronic cell) or NP-μFEC (non-planar microfluidic electronic cell), with the stepwise separation between the CE and WE, dramatic decreases in the I_{EF} are observed. Therefore, it is expected that this severe decrease in I_{EF} will lead to a dramatic increase in the charge transfer resistance R_{ct}. Therefore, EIS characterization is also conducted to visualize the changes in R_{ct} during the movement of the CE and master the working mechanism of the P-μFEC (planar microfluidic electronic cell) and NP-μFEC (non-planar microfluidic electronic cell).

NP-μFEC EIS

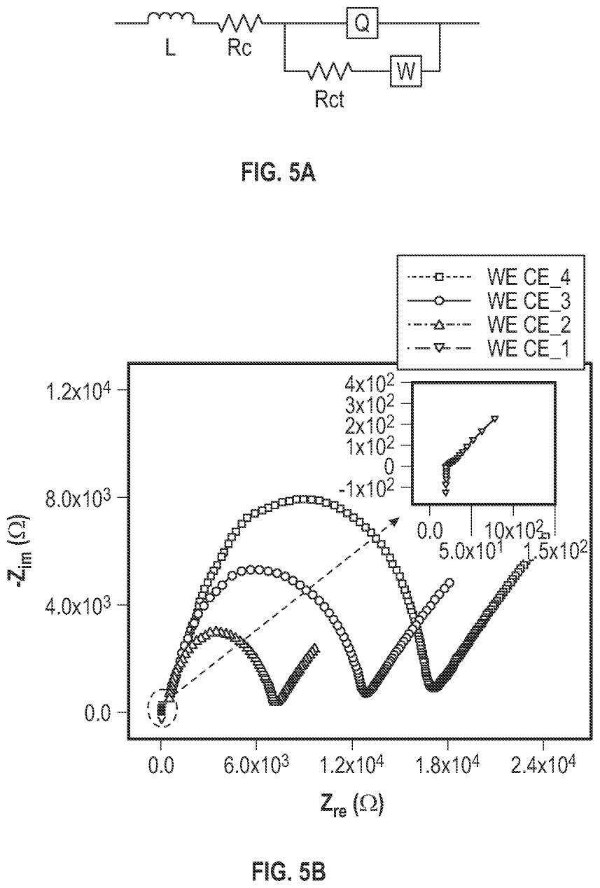

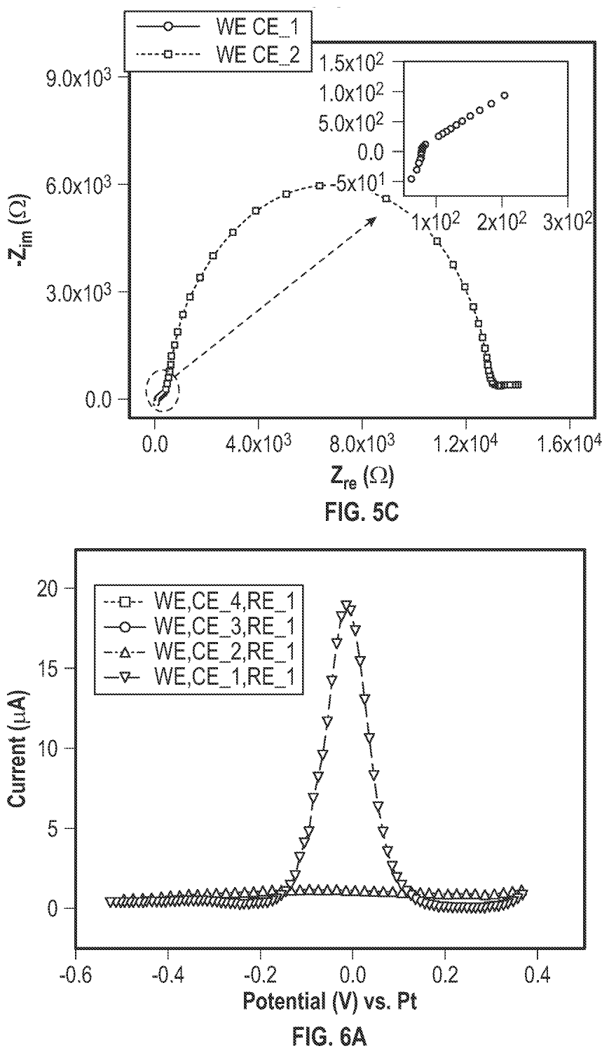

The EIS signature (Nyquist curve) is modeled against the proposed equivalent circuit. In this equivalent circuit, as shown in FIG. 5(a), L is the parasitic inductor in the device due to external noises. Since the external circuit's resistance is ordinarily negligible, therefore, the present inventors do not take it into account in FIG. 5(a). R_{c} represents the resistance of the solution filling between the WE and CE. C_{c} is the cell capacitance originating from the NP-IDμE electrochemical cell. Instead of an ideal double-layer capacitance (C_{dl}), the constant phase element Q is employed due to the inhomogeneity of the interface between the Pt μE and electrolyte [see references 2 and 46 to Li and Ding]. R_{ct} is the charge transfer resistance. The R_{ct} is physically the resistance associated with the electrons' transfer from the electrolyte onto the electrode [see reference 46 to Ding]. The Warburg element (W) impedes the reactants' diffusion rate [see references 2 and 47 to Li and Abouzari, respectively]. Usually, R_{ct} and W are modeled parallel with the Cal or Q because both phenomena are co-occurring [see references 2, 46 and 47 to Li, Ding and Abouzari, respectively].

The solution used for the EIS testing is [Fe(CN)₆]^{3-/4-} (0.01 M) in KCl (1 M)

During EIS measurements, the CE is moved from CE_1 to CE_4. The corresponding EIS spectra (Nyquist curve) are shown in FIG. 5(b). Significant differences in the impedance spectra are observed during the stepwise movement of the CE. When the CE is located at CE_1 (d_{cw}=˜10 μm, while the height of the microfluidic channel maintains at ˜140 μm), the electron transfer process between the electrode and electrolyte solution is speedy, the charge transfer resistance R_{ct} is almost negligible, and thus the electrochemical response is a nearly straight line, as shown in the inset. However, the shift from CE_1 to CE_2, CE_3, and CE_4 resulted in a significant increase in R_{ct}. The equivalent circuit conducts relevant simulation work using the ZSimpWin software (FIGS. 18(a1)-18(a4)). Table 6 below gives the details to each element in the equivalent circuits.

TABLE 6
Value of circuit elements in the equivalent circuit at different CE positions.

| | | L | | | | R_{ct} | | |
|---|---|---|---|---|---|---|---|---|
| System | CE | (Henri) | R_{c} (ohm) | Q (S-secⁿ) | n | (ohm) | W (S-sec^{0.5}) | Chi-square |
| NP- | CE_1 | 3.234E−7 | 40.56 | 2.555E−6 | 0.8217 | 0.048 | 2.062E−6 | 5.18E−4 |
| μFEC | CE_2 | 7.719E−7 | 274.4 | 7.541E−12 | 0.9212 | 6767 | 3.461E−6 | 1.18E−4 |
| | CE_3 | 1.095E−6 | 453.7 | 4.803E−12 | 0.9261 | 12050 | 1.674E−6 | 1.63E−4 |
| | CE_4 | 1.733E−6 | 1003 | 1.109E−12 | 0.9743 | 15460 | 1.248E−6 | 4.73E−4 |

P-μFEC EIS

The impedance spectra (Nyquist curve) of the P-μFEC (planar microfluidic electronic cell) are shown in FIG. 5(c). Based on the well-established equivalent circuit (FIG. 5(a)), the circuit analysis for P-μFEC (FIGS. 19(a1) and 19(a2)) was performed. The circuit element's simulated results are summarized in Table 7 below. Significant differences in the impedance spectra are observed when CE is moved from CE_2 to CE_1. When the CE is placed at CE_1, R_{ct} becomes almost negligible, and thus the impedance response is a nearly straight line, as shown in the inset. This dramatic decrease of R_{ct} makes the electron transfer between the CE and WE more “smooth.”

TABLE 7
Value of circuit elements in the equivalent circuit at different CE positions.

| | | L | | | | R_{ct} | | |
|---|---|---|---|---|---|---|---|---|
| System | CE | (Henri) | R_{c} (ohm) | Q (S-secⁿ) | n | (ohm) | W (S-sec^{0.5}) | Chi-square |
| P-μFEC | CE_1 | 1.716E−7 | 52.4 | 1.578E−6 | 0.5672 | 0.048 | 5.257E−5 | 4.13E−4 |
| | CE_2 | 1.644E−7 | 470.8 | 5.525E−12 | 0.9838 | 12790 | 3.718E−6 | 6.07E−5 |

### DPV Characterization

DPV is often used for electroanalysis, typically in aqueous solutions, as it is usually an order of magnitude more sensitive than the CV mode [see reference 48 to Hussain]. Hence, it was decided to use DPV to determine the detection limit (DL) of [Fe(CN)₆]^{3-/4-} (a proof-of-concept analyte) to compare the performance of P-μFEC and NP-μFEC as an analytical tool.

NP-μFEC DPV

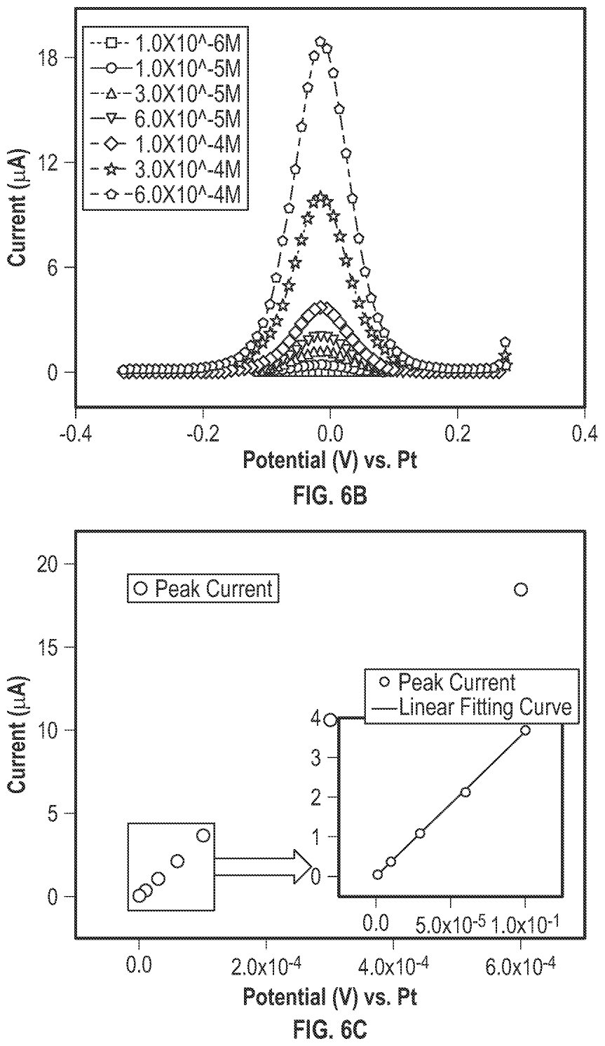

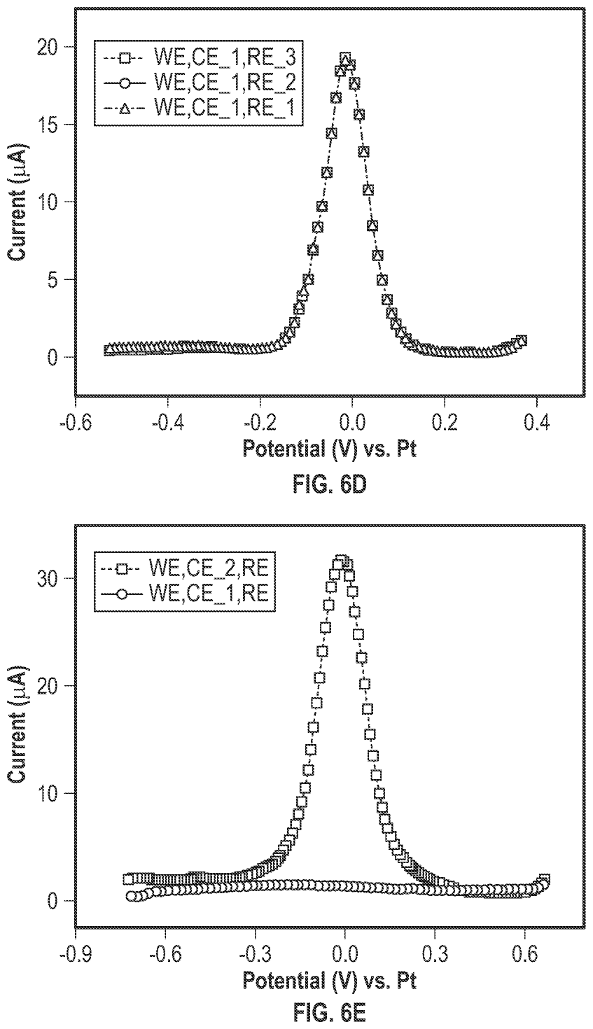

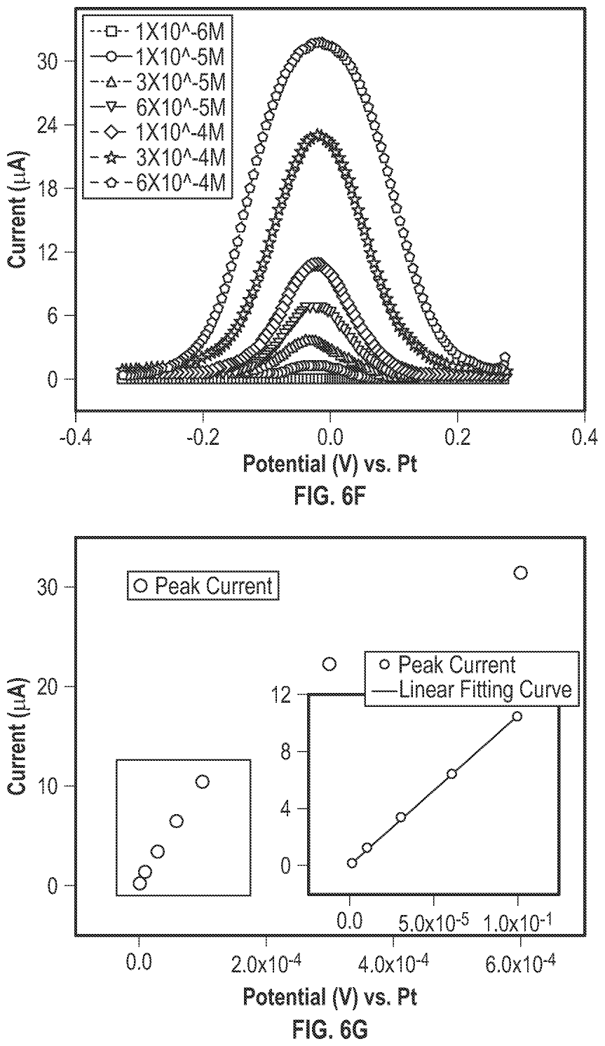

FIGS. 6(a)-6(g) illustrates the DPV results obtained based on NP-μFEC (non-planar microfluidic electronic cell). (a) DPV results obtained at different CE positions. (b) DPV results obtained using different concentrations of [Fe(CN₆)]^{3-/4-} redox couple. (c) Peak currents for [Fe(CN₆)]^{3-/4-} redox process obtained from the voltammograms plotted as a function of increasing [Fe(CN₆)]^{3-/4-} concentration. From 1×10⁻⁴ M to 1×10⁻⁶ M (linear working range), the equation of the fitting line: Peak current Iₚₑₐₖ(μA)=−364683.2×Conc (M)−0.0068; R²=0.9995. (d) DPV results obtained at different RE positions. Results (e) to (g) are the DPV results obtained based on P-μFEC (planar microfluidic electronic cell). (e) DPV results obtained at different CE positions. (f) DPV results obtained from different concentrations of the [Fe(CN)₆]^{3-/4-} redox couple. (g) Peak currents for the [Fe(CN)₆]^{3-/4-} redox process obtained from the voltammograms plotted as a function of increasing [Fe(CN)₆]^{3-/4-} concentration. From 1×10⁻⁴ M to 1×10⁻⁶M (linear working range) the equation of the fitting line: Peak current Iₚₑₐₖ(μA)=−103580.64×Conc (M)+0.238; R²=0.9998. The solution used here for (a), (d), and (e) is [Fe(CN₆)]^{3-/4-} (6×10⁻⁴ M) in KCl (1 M);

FIGS. 6(a)-6(g) compare the differential pulse voltammograms of [Fe(CN)₆]^{3-/4-} obtained at varying electrode configurations. FIG. 6(a) shows a typical voltammogram of the [Fe(CN)₆]^{3-/4-} couple appears at a peak potential (Eₚₑₐₖ) of ca.−15 mV with a full width at half maximum (FWHM) of ˜100 mV under WE/CE_1/RE_1. NP-μFEC's DL under WE/CE_1/RE_1 is studied. Unless otherwise indicated, the concentrations referred here imply the concentrations of [Fe(CN)₆]^{3-/4-} probe. FIG. 6(b) shows an increase in DPV reduction peak currents with the rise of the concentration (see Table 8 below). The linear portion of the calibration curve falls in the range from 1×10⁻⁴ M to 1×10⁻⁶ M with a high coefficient of determination (R²) equal 0.9995, as shown in FIG. 6(c). Therefore, a preliminary value of the DL can be calculated based on the IUPAC recommended formula (Equation 2) [see reference 49 to Long].

$$D L = \frac{K * {S}_{b}}{m} \qquad ( 4 )$$

Here, k is a numerical constant, m is the slope of the plot's linear region, and Sb is the standard deviation of the blank or standard deviation of the ordinate intercept [see reference 50 to Shrivastava]. In accord with IUPAC recommendations, a k value of 3 is applied, corresponding to a 99.87% confidence level [3]. A DL of ˜2.54×10⁻⁶ M is obtained for aqueous [Fe(CN)₆]^{3-/4-} redox couple using the above formula.

TABLE 8
Features of DPV profiles under different [Fe(CN)₆]^{3-/4-} concentrations for the NP-μFEC and P-μFEC

| Concentration (M) | | 6 × 10⁻⁴ | 3 × 10⁻⁴ | 1 × 10⁻⁴ | 6 × 10⁻⁵ | 3 × 10⁻⁵ | 1 × 10⁻⁵ | 1 × 10⁻⁶ |
|---|---|---|---|---|---|---|---|---|
| NP- | Iₚₑₐₖ (μA) | 18.46 | 10.61 | 3.68 | 2.12 | 1.07 | 0.38 | 0.05 |
| μFEC | Eₚₑₐₖ (mV) | −14 | −15 | −14 | −14 | −14 | −16 | −22 |
| | FWHM (mV) | 102 | 100 | 98 | 97 | 100 | 104 | 193 |
| P- | Iₚₑₐₖ (μA) | 31.4 | 22.2 | 10.42 | 6.47 | 3.41 | 1.27 | 0.23 |
| μFEC | Eₚₑₐₖ (mV) | −15 | −17 | −20 | −21 | −31 | −25 | −59 |
| | FWHM (mV) | 220 | 160 | 127 | 130 | 112 | 102 | 72 |

As with the cyclic voltammograms, it is also observed that the variations in the positionings of the RE do not impact the NP-μFEC's DPV response (FIG. 6(d)). For the WE/CE_2/RE_1 configuration, instead of seeing a typical DPV profile, the current (i) versus applied voltage (E) profile shows a significantly reduced current intensity with a broadened FWHM and a pronounced reduction in the redox features. Similar responses are observed for the configurations WE/CE_3,4/RE_1 (FIGS. 22(a)-22(c)). The DPV results demonstrate that only when the horizontal spacing d_{cw} decreases to 0 mm (when the CE and WE are interdigitated), the NP-μFEC can give a more pronounced electrochemical response.

DPV Similarly, the DPV performance of P-μFEC (planar microfluidic electronic cell) to the aqueous [Fe(CN)₆]^{3-/4-} probe is studied. FIG. 6(e) shows the DPV results obtained at different CE positions. As expected, a well-defined DPV profile appears when the CE is fixed at CE_1. The Iₚₑₐₖ is observed at Eₚₑₐₖ=−15 mV with a value of ca.−32 μA and an FWHM of ˜220 mV. FIG. 6(f) shows a gradual increase in the Iₚₑₐₖ with the concentration of [Fe(CN)₆]^{3-/4-} couple. The linear portion of the calibration curve falls in the range from 1×10⁻⁴ M to 1×10⁻⁶ M with an R² equals 0.9998 (FIG. 6(g)). Using Equation (4), a DL of ˜1.8×10⁻⁶ M for aqueous [Fe(CN)₆]^{3-/4-} redox couple can be obtained. Similarly, as the CE moves to CE_2, the characteristic features of the DPV profile are significantly weakened (FIGS. 6(e), 23(a)-23(d)). A well-defined DPV curve shows up only when the CE and WE are interdigitated, with the distance between the adjacent WE and CE fingers being ˜10 μm.

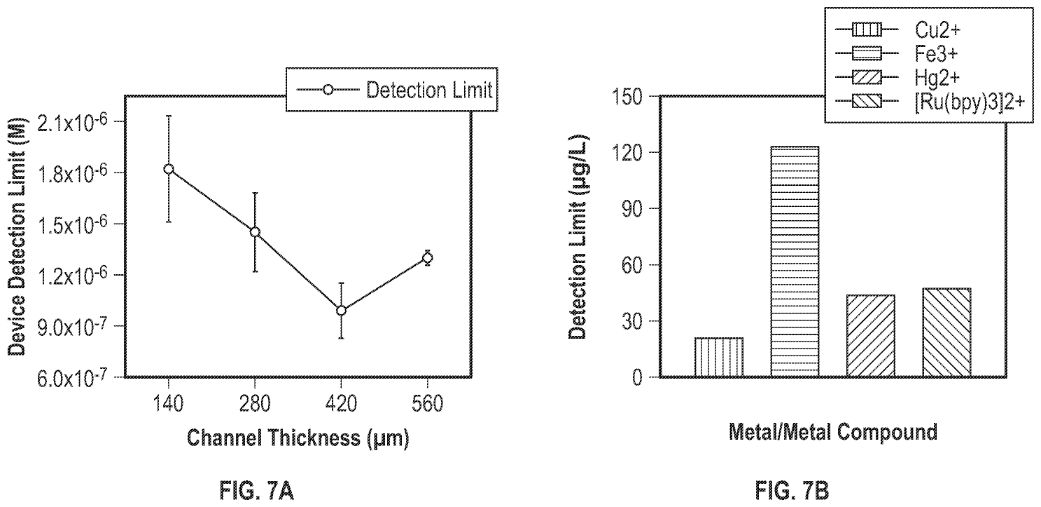

FIG. 7 provides additional experimental results. FIG. 7. (a) DL results based on NP-μFEC using different channel thicknesses. DL equals 1.82×10⁻⁶ (M), 1.45×10⁻⁶ (M), 9.9×10⁻⁷ (M), 1.3×10⁻⁶ (M) when the channel thickness is 140 μm, 280 μm, 420 μm, 560 μm, respectively. (b) Theoretical DL results for different metals (Cu, Fe, Hg) or metal compound ([Ru(bpy)3]²⁺) based on NP-μFEC;

NP-μFEC Vs. P-μFEC

Table 8 summarizes the features of DPV results obtained from the NP-μFEC (non-planar microfluidic electronic cell) and P-μFEC (planar microfluidic electronic cell). Through careful comparison, two representative differences are outlined here:
(i) Different FWHM behaviors: In the NP-μFEC (non-planar microfluidic electronic cell), despite the changes of [Fe(CN)₆]^{3-/4-} concentration in the analyte solution (from 6×10⁻⁴ M to 1×10⁻⁵ M), the FWHM of the NP-μFEC remains at a relatively stable value (˜100 mV). In contrast, the value of FWHM in P-μFEC experiences a gradual decrease as [Fe(CN)₆]^{3-/4-} concentration declines. The reason for the different behavior between the NP-μFEC and P-μFEC in the FWHM is presumably due to the different dominating electrochemical processes for each (semi-infinite/planar diffusion in NP-μFEC vs. radial diffusion in P-μFEC).
(ii) Different electric current behavior: Compared to P-μFEC (planar microfluidic electronic cell), a slower decrease in the Iₚₑₐₖ is observed in NP-μFEC, as illustrated in FIGS. 23(a)-23(d). From the above analysis, it is found that P-μFEC has a smaller DL value (˜1.8×10⁻⁶ M) compared to the NP-μFEC device (˜2.54×10⁻⁶ M). It concludes that, even though the transition of μE arrays from coplanar distribution to non-planar distribution will increase the diffusion distance of ions, this does not significantly influence the μFEC's performance.

Applications of Using NP-μFEC for Heavy Metals Quantification

Other experiments of using the constructed μFEC for heavy metals quantification are conducted. The influence of channel thickness on NP-μFEC's DL is first studied, and relevant results are shown in FIG. 7(a). It is observed that the NP-μFEC experiences a gradual decrease in DL until the thickness of the fluid channel reaches 420 μm. However, an opposite tendency is observed with the continuous increase in channel thickness. It hypothesizes with the increase in the separation between the WE and CE, more reagents fill up within the fluid channel and are supplied to the WE and CE. With the continual increase in the separation, the enlarged diffusion distance of ions deteriorates the NP-μFEC's device performance. However, the overall variation in DL with the channel layer thickness is minimal.

Therefore, an NP-μFEC (non-planar microfluidic electronic cell) using three layers of PSA tapes as the spacer is employed for the rest of the heavy metals' detection work. Herein, three common heavy metals (Copper (Cu), Iron (Fe), and Mercury (Hg)) and one of the most-studied metal compounds ([Ru(bpy)₃]²⁺) are analyzed. DPV results are demonstrated in FIGS. 24(a1)-24(d2). Based on the Equation 3, the theoretical DL for Cu²⁺, Fe³⁺, Hg²⁺, and ([Ru(bpy)₃]²⁺) is 30.5±9.5 μg L⁻¹ (SNR˜2.1), 181±58.5 μg L⁻¹ (SNR˜2.0), 12.4±1.95 μg L⁻¹ (SNR˜5.0), 83±9 μg L⁻¹ (SNR˜2.7), respectively, which meets EPA's water contamination level for Cu, Fe (1300 μg L⁻¹, 300 μg L⁻¹, respectively) and is close to the EPA level for Hg (2 μg L⁻¹). Therefore, the acquired DLs demonstrate that the cost-effective, fast-preparation NP-μFEC (non-planar microfluidic electronic cell) of the present disclosure can be an ideal new analytical tool to other research groups for applications of monitoring heavy metals (Cu, Fe, among others) in wastewater.

### Conclusions

An assembly of non-planar interdigitated microelectrodes (NP-IDμE) with improved electric field penetration is introduced in the present disclosure. The NP-IDμE based microfluidic electrochemical cell (μFEC) fabrication has been detailed and thoroughly examined its electrochemical characteristics. Compared with classical planar interdigitated microelectrodes (P-IDμE) based μFEC (P-μFEC), the non-planar model (non-planar microfluidic electrochemical cell) has many advantages. The convenient fabrication process and the vertical distributed electric field feature non-planar microfluidic electrochemical cell more attractive as an electrochemical tool.

Electrochemical characterizations (CV, DPV, and EIS) are carried out to illustrate, examine and fundamentally understand the electrochemical behaviors of the non-planar microfluidic electrochemical cell. Specifically, there is an interest in the influence of the 3D spatial orientation of the μE arrays on electrochemical behavior. The representative findings are summarized here:
(i) From the CV tests, for the non-planar microfluidic electrochemical cell (when the CE and WE are “Interdigitated”), the electrochemical process is predominantly controlled by semi-infinite diffusion, which differs from the radial diffusion in the P-μFEC (planar microfluidic electrochemical cell).
(ii) The effect of the distance between the electrodes (WE, CE, and RE) and their positions are carefully studied. Based on the CV studies, the inserted RE position's change does not affect the final electrochemical performance of the non-planar microfluidic electrochemical cell. However, the spacing between the CE and WE does.
(iii) FEA simulation results demonstrate that for the non-planar microfluidic electrochemical cell, most of the microchannel layer (˜66.00%) falls in a relatively strong I_{EF} range (from 9×10³ to 6×10³ V/m). However, for the P-μFEC (planar microfluidic electrochemical cell), most of its channel (˜75.77%) falls in a relatively weak I_{EF} interval (<3×10³ V/m).
(iv) As a result, the non-planar microfluidic electrochemical cell shows excellent performance to aqueous [Fe(CN)₆]^{3-/4-} redox couple. The DPV tests find that the non-planar microfluidic electrochemical cell can show a similar detection limit DL (˜2.54×10⁻⁶ M) to that (˜1.8×10⁻⁶ M) in the P-μFEC (planar microfluidic electrochemical cell).
(v) Finally, a constructed NP-μFEC is employed for heavy metal detection. Additionally, the acquired theoretical DL values for Cu²⁺ (30.5±9.5 μg L⁻¹), Fe³⁺ (181±58.5 μg L⁻¹), and Hg²⁺ (12.4±1.95 μg L⁻¹) demonstrate that the cost-effective, fast-preparation NP-μFEC of the present disclosure can be an ideal new analytical tool to other research groups for the applications of monitoring heavy metals (Cu, Fe, among others) in wastewater.

The cumulative results demonstrate the non-planar microfluidic electrochemical cell's general effectiveness for efficient probing of electrochemical properties of electroactive analytes. This provides the promise of the non-planar microfluidic electrochemical cell as a lab-on-a-chip microfluidic platform for sensitive electrochemical analysis and detection of analytes' where samples are limited in volume.

### Supporting Information

### (i) Fabrication of Microelectrodes

Microelectrodes (μEs) used in the present disclosure are deposited using Electron Beam Evaporation at the Nanofabrication Facility Advances Science Research Centre at the City University New York. Standard lithography techniques are used for patterning. For ease of understanding, the detailed preparation process for μEs is illustrated in FIG. 8. Commercially available glass slides 75 mm×25 mm×1 mm (height×width×length) are used as the substrate. Before use, the substrate is cleaned in a mixture of sulfuric acid and hydrogen peroxide (3:1, volume ratio) at 100° C. for 30 min. Two chemical reagents, HMDS, and AZ1512 are used to prepare the positive photoresist film. First, a thin layer of HMDS is spin-coated onto the substrate (1000 rpm, ˜1 min) to prepare an adhesion layer for the subsequent development of the AZ1512 photoresist film. Next, AZ1512 is spin-coated onto the previously prepared HMDS/glass substrates at 3000 rpm for 1 min. After baking at 110° C. for ˜1 min, a previously reported lithography method is used for patterning.^{1, 2} The electrode patterns slowly appear through the treatment in the AZ300 MIF developer solution for ˜50 s. Finally, a Ti (10 nm)/Pt (90 nm) multilayer is deposited by Electron Beam Evaporation, removing the resists. Consequently, the substrates deposited with Pt μE layer are obtained. Here, each μE array contains 250 electrode fingers and each electrode finger with the dimensions of 500 um×10 um×100 nm in length×width×height, respectively.

### (ii) Preparation of the NP-μFEC

Unlike the traditional polydimethylsiloxane (PDMS) method to prepare microfluidic channels, a polyester-based pressure-sensitive adhesive (PSA) layer was used in one embodiment to make a sandwiched fluid channel between the top and bottom Pt μE layers, as shown in FIG. 9. First, a Cricut® machine cuts the desired channel with a 60 mm length, 500 μm width (tape height is˜140 μm). The NP-μFEC (non-planar microfluidic electronic cell) has four pairs of non-planar interdigitated microelectrode (NP-IDμE) arrays. The details of the preparation of NP-IDμE have been reported elsewhere.^{3, 4} Briefly, the tailored microfluidic channel with the desired channel pattern is positioned over a glass slide deposited with the Pt μEs. Next, a Cricut machine is used to cut the channel. Post cutting, the channel is affixed to the bottom μE glass slide. The second glass slide that with μE is subsequently used to cover the microfluidic channel. Throughout the process, a microscope is used to adjust the top and bottom μEs so that the electrodes eventually align to form an “interdigitated” layout structure.

FEA Simulation (Planar Vs. Non-Planar)

Time-dependent COMSOL simulations of potassium Ferri/ferrocyanide (K3/K4Fe(CN)6)'s concentration distribution profiles are recorded (FIGS. 17(a1)-17(b2)). Of note, for this simulation work, Butler-Volmer electrode kinetics are chosen. The [Fe(CN)₆]^{3-/4-} bulk solution concentration keeps at ˜10 mM. From FIGS. 17(a1) and 17(a2), it can be directly observed that [Fe(CN)₆]^{3-/4-} gets reduced/oxidized between the electrode fingers of the WE and CE. This process is sometimes referred to as “redox cycling” [4]. The observation of “redox cycling” perfectly explains the appearance of sigmoidal cyclic voltammograms in P-μFEC. However, for NP-μFEC, due to the overlap of diffusion zones, the linear diffusion process is observed (FIGS. 17(b1) and 17(b2)) [see reference 5 to Rooney].

### Ohmic Drop Calculation Between RE and WE in Non-Planar Microfluidic Electrochemical Cell

The currents that flow between the WE and RE_1,2,3 (scan rate=30 mV/s) are recorded and displayed in FIG. 21. This figure shows the changes in the current when the potential difference between the WE and RE changes from 0 to 500 mV. When the potential difference reaches 500 mV, the current values equal ˜16.9 μA with RE located at RE_1. When RE is located at RE_2 and RE_3, the current value is ˜12.9 μA and ˜9.3 respectively. Thus, the ohmic drop due to the solution between RE_1 and WE is approximately 16.9 μA*319 Ω=˜5.4 mV. The ohmic drop between RE_2 and WE is approximately 12.9 μA*572 Ω=˜7.4 mV. The ohmic drop between RE_3 and WE is approximately 9.3 μA*1033 Ω=˜9.6 mV.

### Ohmic Drop Calculation Between CE and WE in Non-Planar Microfluidic Electrochemical Cell

From the CV results (FIGS. 2(a4), 2(a5), 10(c) and 10(d)), it can be seen that when the potential difference reaches 500 mV, the current flows between WE and CE_1,2,3,4 is equal to ˜55.44 μA, ˜52.23 μA, ˜47.25 μA, ˜45.48 μA, respectively. Therefore, based on the EIS simulated results (see Table 6), the ohmic drop between CE_1 and the WE is approximate ˜55.44 μA*50.6 Ω=˜2.8 mV. Similarly, the ohmic drop between CE_2/3/4 and the WE are ˜14.3 mV, ˜21.5 mV, ˜45.6 mV, respectively.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

### LIST OF REFERENCES

These references are hereby incorporated by reference in their entirety, for all purposes.
[1] J. S. Daniels, N. Pourmand, Label-free impedance biosensors: Opportunities and challenges, Electroanalysis: An International Journal Devoted to Fundamental and Practical Aspects of Electroanalysis, 19 (2007) 1239-1257.
[2] Z. Li, Y.-H. Cheng, L. Feng, J. Neil, R. M. P. Antonio, M. Rahman, J. Yang, S. Azizighannad, S. Mitra, S. Basuray, Communication—Electrochemical Impedance Signature of a Non-Planar, Interdigitated, Flow-Through, Porous, Carbon-Based Microelectrode, Journal of The Electrochemical Society, 166 (2019) B1669-B1672.
[3] S. Chatterjee, M. S. Fujimoto, Y. H. Cheng, R. Kargupta, J. A. Soltis, R. K. Motkuri, S. Basuray, Improving the sensitivity of electrochemical sensors through a complementary luminescent mode: A new spectroelectrochemical approach, Sensors and Actuators B: Chemical, 284 (2019) 663-674.
[4] J. Min, A. J. Baeumner, Characterization and optimization of interdigitated ultramicroelectrode arrays as electrochemical biosensor transducers, Electroanalysis: An International Journal Devoted to Fundamental and Practical Aspects of Electroanalysis, 16 (2004) 724-729.
[5] M. B. Rooney, D. C. Coomber, A. M. Bond, Achievement of near-reversible behavior for the [Fe (CN) 6] 3-/4-redox couple using cyclic voltammetry at glassy carbon, gold, and platinum macrodisk electrodes in the absence of added supporting electrolyte, Analytical chemistry, 72 (2000) 3486-3491.
[6] C. Lee, F. C. Anson, Inhibition of the electroreduction of Fe (CN) 3-6 at microelectrodes in the absence of supporting electrolyte. Mediation of the inhibited reduction by methyl viologen, Journal of electroanalytical chemistry and interfacial electrochemistry, 323 (1992) 381-389.
[7] M. Ciszkowska, Z. Stojek, Voltammetry in solutions of low ionic strength. Electrochemical and analytical aspects, Journal of Electroanalytical Chemistry, 466 (1999) 129-143.
[8] M. Nishizawa, I. Uchida, Microelectrode-based characterization systems for advanced materials in battery and sensor applications, Electrochimica acta, 44 (1999) 3629-3637.
[9] J. Kawiak, P. J. Kulesza, Z. Galus, A search for conditions permitting model behavior of the Fe (CN) 3-/4- 6 system, Journal of electroanalytical chemistry and interfacial electrochemistry, 226 (1987) 305-314.
[10] A. Bratov, N. Abramova, J. Ramon-Azcón, A. Merlos, F. Sanchez-Baeza, M.-P. Marco, C. Dominguez, Characterisation of the interdigitated electrode array with tantalum silicide electrodes separated by insulating barriers, Electrochemistry communications, 10 (2008) 1621-1624.
[11] P. Van Gerwen, W. Laureyn, W. Laureys, G. Huyberechts, M. O. De Beeck, K. Baert, J. Suls, W. Sansen, P. Jacobs, L. Hermans, Nanoscaled interdigitated electrode arrays for biochemical sensors, Sensors and Actuators B: Chemical, 49 (1998) 73-80.
[12] Y.-H. Cheng, P. A. R. Moura, L. Zhenglong, L. Feng, S. Arokiam, J. Yang, M. Hariharan, S. Basuray, Effect of electrode configuration on the sensitivity of nucleic acid detection in a non-planar, flow-through, porous interdigitated electrode, Biomicrofluidics, 13 (2019) 064118.
[13] S. R. A. Ruth, V. R. Feig, M.-g. Kim, Y. Khan, J. K. Phong, Z. Bao, Flexible Fringe Effect Capacitive Sensors with Simultaneous High-Performance Contact and Non-Contact Sensing Capabilities, Small Structures, (2020) 2000079.
[14] Y.-H. Cheng, R. Kargupta, D. Ghoshal, Z. Li, C. Chande, L. Feng, S. Chatterjee, N. Koratkar, R. K. Motkuri, S. Basuray, ESSENCE—A rapid, shear-enhanced, flow-through, capacitive electrochemical platform for rapid detection of biomolecules, Biosensors and Bioelectronics, 182 (2021) 113163.
[15] H. Sugime, T. Ushiyama, K. Nishimura, Y. Ohno, S. Noda, An interdigitated electrode with dense carbon nanotube forests on conductive supports for electrochemical biosensors, Analyst, 143 (2018) 3635-3642.
[16] A. Abellán-Llobregat, L. Vidal, R. Rodriguez-Amaro, A. Berenguer-Murcia, A. Canals, E. Morallon, Au-IDA microelectrodes modified with Au-doped graphene oxide for the simultaneous determination of uric acid and ascorbic acid in urine samples, Electrochimica Acta, 227 (2017) 275-284.
[17] A. Bratov, J. Ramón-Azcón, N. Abramova, A. Merlos, J. Adrian, F. Sanchez-Baeza, M.-P. Marco, C. Dominguez, Three-dimensional interdigitated electrode array as a transducer for label-free biosensors, Biosensors and bioelectronics, 24 (2008) 729-735.
[18] E. W. Young, D. J. Beebe, Fundamentals of microfluidic cell culture in controlled microenvironments, Chemical Society Reviews, 39 (2010) 1036-1048.
[19] D. Daniel, I. G. Gutz, Microfluidic cells with interdigitated array gold electrodes: Fabrication and electrochemical characterization, Talanta, 68 (2005) 429-436.
[20] A. Saha, S. Mitra, Microfluidics and nanofluidics handbook: chemistry, physics, and life science principles, Taylor & Francis Group, 2012.
[21] Y. H. Cheng, D. Barpaga, J. A. Soltis, V. Shutthanandan, R. Kargupta, K. S. Han, B. P. McGrail, R. K. Motkuri, S. Basuray, S. Chatterjee, Metal-Organic Framework-Based Microfluidic Impedance Sensor Platform for Ultrasensitive Detection of Perfluorooctanesulfonate, ACS Appl Mater Interfaces, 12 (2020) 10503-10514.
[22] S. Basuray, S. Senapati, A. Aijian, A. R. Mahon, H. C. Chang, Shear and AC Field Enhanced Carbon Nanotube Impedance Assay for Rapid, Sensitive, and Mismatch-Discriminating DNA Hybridization, ACS nano, 3 (2009) 1823-1830.
[23] F. Zhang, J. Liu, I. Ivanov, M. C. Hatzell, W. Yang, Y. Ahn, B. E. Logan, Reference and counter electrode positions affect electrochemical characterization of bioanodes in different bioelectrochemical systems, Biotechnology and bioengineering, 111 (2014) 1931-1939.
[24] Z. Li, J. Ni, S. Zhang, C. Li, Y. Du, Y. Zhang, H. Cai, J. Li, J. Zhang, Effect of incorporation of highly-ordered a-Ge: H nanoparticles on the performance of perovskite solar cells, Micro & Nano Letters, 13 (2018) 1111-1116.
[25] S. Cheng, H. Liu, B. E. Logan, Increased performance of single-chamber microbial fuel cells using an improved cathode structure, Electrochemistry communications, 8 (2006) 489-494.
[26] G. Hsieh, T. O. Mason, E. Garboczi, L. Pederson, Experimental limitations in impedance spectroscopy: Part III. Effect of reference electrode geometry/position, Solid State Ionics, 96 (1997) 153-172.
[27] R. A. da Silva, E. G. de Almeida, A. C. Rabelo, A. T. da Silva, L. F. Ferreira, E. M. Richter, Three electrode electrochemical microfluidic cell: construction and characterization, Journal of the Brazilian Chemical Society, 20 (2009) 1235-1241.
[28] Y. Li, W. Van Roy, L. Lagae, P. M. Vereecken, Effects of counter electrode induced redox cycling on Fe (III) reduction within microfluidic electrochemical cells, Journal of The Electrochemical Society, 161 (2014) E128.
[29] C. Amatore, N. Da Mota, C. Sella, L. Thouin, Theory and experiments of transport at channel microband electrodes under laminar flows. 1. Steady-state regimes at a single electrode, Analytical chemistry, 79 (2007) 8502-8510.
[30] H. Tantang, J. Xiao, J. Wei, M. B. E. Chan-Park, L. J. Li, Q. Zhang, Low-Cost and Ultra-Strong p-Type Doping of Carbon Nanotube Films by a Piranha Mixture, European Journal of Inorganic Chemistry, 2011 (2011) 4182-4186.
[31] C. A. Schroll, S. Chatterjee, W. R. Heineman, S. A. Bryan, Semi-infinite linear diffusion spectroelectrochemistry on an aqueous micro-drop, Analytical chemistry, 83 (2011) 4214-4219.
[32] N. Elgrishi, K. J. Rountree, B. D. McCarthy, E. S. Rountree, T. T. Eisenhart, J. L. Dempsey, A practical beginner's guide to cyclic voltammetry, Journal of Chemical Education, 95 (2018) 197-206.
[33] S. Konopka, B. McDuffie, Diffusion coefficients of ferri-and ferrocyanide ions in aqueous media, using twin-electrode thin-layer electrochemistry, Analytical Chemistry, 42 (1970) 1741-1746.
[34] H.-C. Chang, C.-C. Wu, S.-J. Ding, I.-S. Lin, I.-W. Sun, Measurement of diffusion and partition coefficients of ferrocyanide in protein-immobilized membranes, Analytica chimica acta, 532 (2005) 209-214.
[35] K. B. Oldham, N. P. Stevens, Uncompensated resistance. 2. The effect of reference electrode nonideality, Analytical chemistry, 72 (2000) 3981-3988.
[36] J.-M. Savéant, Elements of molecular and biomolecular electrochemistry, Willey-VCH, New Jersey, (2006).
[37] J. C. Myland, K. B. Oldham, Uncompensated resistance. 1. The effect of cell geometry, Analytical chemistry, 72 (2000) 3972-3980.
[38] R. O. Kadara, N. Jenkinson, C. E. Banks, Characterization and fabrication of disposable screen printed microelectrodes, Electrochemistry Communications, 11 (2009) 1377-1380.
[39] S. Hwang, C. N. LaFratta, V. Agarwal, X. Yu, D. R. Walt, S. Sonkusale, CMOS microelectrode array for electrochemical lab-on-a-chip applications, IEEE Sensors Journal, 9 (2009) 609-615.
[40] Y. Yang, C. Li, L. Yin, M. Liu, Z. Wang, Y. Shu, G. Li, Enhanced charge transfer by gold nanoparticle at DNA modified electrode and its application to label-free DNA detection, ACS applied materials & interfaces, 6 (2014) 7579-7584.
[41] E. Kostal, S. Kasemann, C. Dincer, S. Partel, Impedimetric characterization of interdigitated electrode arrays for biosensor applications, Multidisciplinary Digital Publishing Institute Proceedings, 2018, pp. 899.
[42] S. Ismail, N. Mahmood, M. A. Razak, Optimization of interdigitated electrodes in electric field distribution and thermal effect, Journal of Telecommunication, Electronic and Computer Engineering (JTEC), 9 (2017) 85-89.
[43] K. V. Singh, A. M. Whited, Y. Ragineni, T. W. Barrett, J. King, R. Solanki, 3D nanogap interdigitated electrode array biosensors, Analytical and bioanalytical chemistry, 397 (2010) 1493-1502.
[44] A. Bratov, S. Brosel-Oliu, N. Abramova, Label-Free Impedimetric Biosensing Using 3D Interdigitated Electrodes, Label-Free Biosensing, Springer2017, pp. 179-198.
[45] Y. H. Cheng, D. Barpaga, J. A. Soltis, V. Shutthanandan, R. Kargupta, K. S. Han, B. P. McGrail, R. K. Motkuri, S. Basuray, S. Chatterjee, Metal—Organic Framework-Based Microfluidic Impedance Sensor Platform for Ultrasensitive Detection of Perfluorooctanesulfonate, ACS Applied Materials & Interfaces, 12 (2020) 10503-10514.
[46] S. Ding, C. Mosher, X. Y. Lee, S. R. Das, A. A. Cargill, X. Tang, B. Chen, E. S. McLamore, C. Gomes, J. M. Hostetter, Rapid and label-free detection of interferon gamma via an electrochemical aptasensor comprising a ternary surface monolayer on a gold interdigitated electrode array, ACS sensors, 2 (2017) 210-217.
[47] M. S. Abouzari, F. Berkemeier, G. Schmitz, D. Wilmer, On the physical interpretation of constant phase elements, Solid State Ionics, 180 (2009) 922-927.
[48] G. Hussain, D. S. Silvester, Comparison of voltammetric techniques for ammonia sensing in ionic liquids, Electroanalysis, 30 (2018) 75-83.
[49] G. L. Long, J. D. Winefordner, Limit of detection. A closer look at the IUPAC definition, Analytical chemistry, 55 (1983) 712A-724A.
[50] A. Shrivastava, V. B. Gupta, Methods for the determination of limit of detection and limit of quantitation of the analytical methods, Chronicles of young scientists, 2 (2011) 21.

1. An electrochemical cell, comprising:
a top microelectrode layer;
a bottom microelectrode layer;
a middle layer located between the top microelectrode layer and the bottom microelectrode layer, and
the top microelectrode layer, the bottom microelectrode layer and the middle layer cooperating to form a three-dimensional and non-planar structure.

2. The electrochemical cell of claim 1, wherein the middle layer comprises a pressure-sensitive adhesive layer.

3. The electrochemical cell of claim 1, wherein the top microelectrode layer is a first glass microelectrode layer.

4. The electrochemical cell of claim 3, wherein the bottom microelectrode layer is a second glass microelectrode layer.

5. The electrochemical cell of claim 4, wherein the middle layer is polyester-based.

6. The electrochemical cell of claim 5, wherein the middle layer is comprised of a material selected from the group consisting of double-sided pressure-sensitive adhesive, silicone transfer film, polydimethylsiloxame (PDMS) and polyester (PET).

7. The electrochemical cell of claim 6, wherein the middle layer includes a fluid channel.

8. The electrochemical cell of claim 7, wherein the first and second glass microelectrode layers include a first microelectrode array and a second microelectrode array, respectively.

9. The electrochemical cell of claim 8, wherein the first microelectrode array includes an anode and the second microelectrode array includes a cathode.

10. The electrochemical cell of claim 8, wherein the first microelectrode array and the second microelectrode array are each chosen from the group consisting of a working electrode, a counter electrode and a reference electrode.

11. The electrochemical cell of claim 9, wherein the first glass microelectrode layer includes a fluid inlet and a fluid outlet in fluid communication with the fluid channel of the middle layer.

12. The electrochemical cell of claim 8, wherein at least one of the first and second microelectrode arrays includes a metal electrode with fingers arranged in a comb-like pattern.

13. The electrochemical cell of claim 12, wherein the fingers are interdigitated in a planar configuration.

14. The electrochemical cell of claim 13, wherein at least some of the interdigitated fingers adjacent to each other have opposite polarity voltages applied thereto.

15. A method of manufacturing an electrochemical cell, comprising the steps of:
providing a first microelectrode layer;
providing a second microelectrode layer;
providing a middle layer, the middle layer being between the first microelectrode layer and the second microelectrode layer, and
the first microelectrode layer, the second microelectrode layer and the middle layer cooperating to form a three-dimensional and non-planar structure.

16. The method of manufacturing an electrochemical cell of claim 15 wherein the middle layer comprises a pressure-sensitive adhesive layer.

17. The method of manufacturing an electrochemical cell of claim 15 wherein the first microelectrode layer is a first glass microelectrode layer and the second microelectrode layer is a second glass microelectrode layer.

18. The method of manufacturing an electrochemical cell of claim 15 wherein the middle layer includes a fluid channel.

19. An electrochemical cell, comprising:
a first microelectrode layer configured as an anode;
a second microelectrode layer configured as a cathode;
a middle layer located between the top microelectrode layer and the bottom microelectrode layer, and
the first microelectrode layer, the second microelectrode layer and the middle layer cooperating to form a three-dimensional and non-planar structure.

20. The electrochemical cell of claim 19, wherein the first microelectrode layer and the second microelectrode layer are each chosen from the group consisting of a reference electrode, a working electrode and a counter electrode.
